(19) United States
(12) Patent Application Publication
(10) Pub. No.: US 2006/0155639 A1
(43) Pub. Date: Jul. 13, 2006

(54) System and method for automated process of deal structuring

(76) Inventors: Joan Lynch, Jenkintown, PA (US); John Howard McNair, Marlton, NJ (US); Stephen John Polito, Sewell, NJ (US); Roberto E. D'Urbano, Mt. Holly, NJ (US); Milton Riseman, Radnor, PA (US); William Kaiser, Maple Glen, PA (US)

Correspondence Address: REED SMITH LLP, 2500 ONE LIBERTY PLACE, 1650 MARKET STREET, PHILADELPHIA, PA, 19103, US

(21) Appl. No.: 10/876,379

(22) Filed: Jun. 24, 2004

Related U.S. Application Data
(63) Continuation-in-part of application No. 10/040,938, filed on Jan. 7, 2002, now Pat. No. 6,901,384.
Application No. 10/040,938 is a continuation of application No. 09/586,462, filed on Jun. 3, 2000, now Pat. No. 6,823,319.

(51) Int. Cl. G06Q 40/00

(52) U.S. Cl. 705/38

(57) ABSTRACT

A method of automatically generating, based on the preferences of a potential borrower as entered by a third party, multiple alternative loan proposals requested by the third party, are disclosed. The method of automatically generating, based on the preferences of a potential borrower as entered by a third party, multiple alternative loan proposals requested by the third party, includes the steps of prompting the third party for at least one loan parameter, requesting from the third party information relating to the potential borrower, accessing in substantially real time information relating to the credit history of the potential borrower, applying at least one loan origination rule to the at least one loan parameter and the information relating to the potential borrower, applying at least one strategy to at least one result of said applying at least one loan origination rule, generating at least two loan proposals in accordance with the at least one result of said applying at least one loan origination rule and said applying at least one strategy, wherein at least one loan proposal is automatically approved, and wherein each loan proposal includes a plurality of loan proposal factors, and presenting the third party with the at least two loan proposals for presentation to the potential borrower.

### CROSS REFERENCE TO RELATED APPLICATIONS

This application is a continuation in part of U.S. patent application Ser. No. 10/040,938, filed Jan. 7, 2002 which is a continuation in part of U.S. patent application Ser. No. 09/586,462, filed Jun. 3, 2000, which are incorporated by reference, as if fully set forth in their respective entirety herein.

### BACKGROUND OF THE INVENTION

1. Field of the Invention

The present invention relates generally to transactions, and more particularly to a method and system for deal structuring.

2. Description of the Background

The structuring of deals for customers has traditionally been a protracted and inefficient process. Customer 114 might provide copious amounts of financial and potential collateral information to a salesperson, which may attempt to structure a deal from a commercial lender to customer 114 or Broker. This process may require the expenditure of large amounts of time on the part of both the requestor of a loan and the salesperson.

The typical loan originating process, for example, commences when a potential borrower, i.e. a customer, first contacts a loan salesperson by telephone. The salesperson extracts the information required from the potential borrower to generate a provisional loan, without knowing whether the mortgage loan will meet a lender's underwriting policies. The salesperson may then request that confirmation information, such as income documentation, be presented.

The information, and all of the paperwork, is then routed to the lender's processing department, where additional documents, such as credit reports, might be requested and retrieved, either manually or automatically. Eventually, the documents are forwarded to an underwriter, who then determines whether the requested loan meets the lender's underwriting policies, and whether any further documentation is necessary, and may approve the loan.

If the loan does not meet the lender's underwriting policies, the underwriter and the salesperson may then negotiate changes to the terms of the loan necessary to meet these policies. After the underwriter and the salesperson agree on the changed terms, the salesperson and the potential borrower must negotiate with respect to the terms agreed on by the underwriter and the salesperson.

Any further amendments agreed to by the potential borrower and the salesperson might require further negotiations between the salesperson and the underwriter, and the loan origination process thus continues iteratively until all parties come to an agreement, all possible loan permutations are rejected, or the potential borrower abandons the process in frustration. If the parties reach an agreement, the process continues through the approval, closing, and servicing stages.

### SUMMARY OF THE INVENTION

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a deal structuring system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. Additionally, it should be noted that, although the invention disclosed herein may make reference to specific deal structures, such as sub-prime products, the invention may be applied in substantially the same manner as disclosed herein to numerous deal structures, such as, but not limited to, conforming, non-conforming, prime, sub-prime, fixed, jumbo, balloon, etc. Further, although certain examples of the present invention are discussed with specific reference to loans, it will be apparent to those skilled in the art that the present invention may be used for all deal types, including, but not limited to, insurance, for example. Additionally, as used herein, the term borrower shall also include, for example, co-borrowers, co-signers, and the like. The disclosure hereinbelow is directed to all such variations and modifications to deal structure known to those skilled in the art.

The following definitions are provided to aid in construing the specification and claims of the present application:

Broker: Broker are agents who negotiates or obtains a loan for a customer from a lender, for example, without taking title to the loan itself.

Expert System: Expert systems enable computers to make decisions for solving complex nonnumeric problems. Whereas conventional computer programs principally perform functions such as data manipulation, calculations, and data storage and retrieval, expert systems use a knowledge base and an inference engine to make decisions. The expert system of the present invention may be implemented with a commercially available rule-based expert system, such as ART-IM (provided by Inference Corporation), ART* Enterprise (provided by Brightware, Inc.), or Arity/Prolog (provided by Arity Corp.).

Knowledge Base: a knowledge base is a collection of rules that represent the human expertise of a particular knowledge domain. Rules are typically constructed in an IF-THEN-ELSE format, e.g., IF Property Type=High Rise AND State=NY THEN Proceed ELSE Flag For Review. The knowledge base is typically stored in a storage medium of a computer.

Inference Engine: an inference engine is a software deal structuring that runs on a computer. An expert system operates by running a knowledge base through an inference engine and applying all of the rules to the input data for a given problem.

Customer: A customer is a consumer, business, or other entity that deals directly with the automated process of deal structuring, or with a customer service representative accessing the automated process of deal structuring. Although in certain preferred embodiments of the present invention a customer must be a natural person, in other embodiments of the present invention a customer may be a corporation, partnership, or other entity. A customer is, for example, a consumer desiring a deal, such as a loan, a business seeking deal information, a third party broker, or a partner (such as a mortgage broker) seeking deal related information or services, such as real-time pricing terms.

Customer Service Representative (“CSR”): An employee, an affiliate, or a partner of the offeror, such as a lender, whose responsibilities may include assisting a customer to apply for or consummate a loan, or whose responsibilities include interacting with customer 114 in connection with the development or consummation of a deal consummated loan. CSR's include, but are not limited to, business representatives, loan officers, loan processors, risk reviewers, auditors, and the like.

Underwriter (“UW”): An underwriter is responsible for verifying that a proposed deal, such as a proposed loan, complies with an offeror's, i.e. a lender's, underwriting standards, and approves or disapproves the deal.

Credit Reporting Agency (“CRA”): A third party entity that monitors the credit history of a natural person, corporation, partnership, or other entity, including the entity's loan repayment history, bankruptcy history, public record history, credit history inquiries, and the like.

Credit Grading: The conversion of information contained in a customer's credit history into a qualitative factor that is suitable for evaluation within the deal structuring process. The credit grade is transformable, using a set of credit transformation rules, to a format compatible with the credit grade scale of the lender or of a third party lender.

Product/Deal: A product or deal is offered by an offeror, such as a lender, and may include, for example, a fixed rate loan, an adjustable rate loan, a balloon loan, a hybrid, or other loan. A product or deal may also be differentiated by term, lien position, origination rules or fees, origination points, or other characteristics.

Exclusionary Rules. Exclusionary Rules are a sub-set of origination rules. Exclusionary rules result in a customer being excluded from a deal offer.

Loan-to-Value (“LTV”) Ratio. The ratio of the gross amount of a loan to the value of the property securing the loan. LTV is commonly expressed as a percentage calculated by dividing the gross loan amount by the collateral value.

Combined Loan to Value (“CLTV”) Ratio. The ratio of the sum of the gross amount of a loan and the gross amounts of all other senior loans secured by the same collateral to the value of the collateral securing the loan. CLTV is commonly expressed as a percentage calculated by dividing the sum of the gross loan amount and the gross amounts of all other senior loans and/or liens secured by the same collateral.

Debt-to-Income (“DTI”) Ratio. The ratio of monthly debt service to the amount of monthly income. The monthly debt service is the sum of the debt service on all of a customer's debts. When DTI ratios are evaluated pursuant to a determination of whether a loan should be offered to a customer, the DTI ratio is calculated including the payments required to service the loan being requested and excluding any debt that may be paid off or discharged if the loan were approved and consummated.

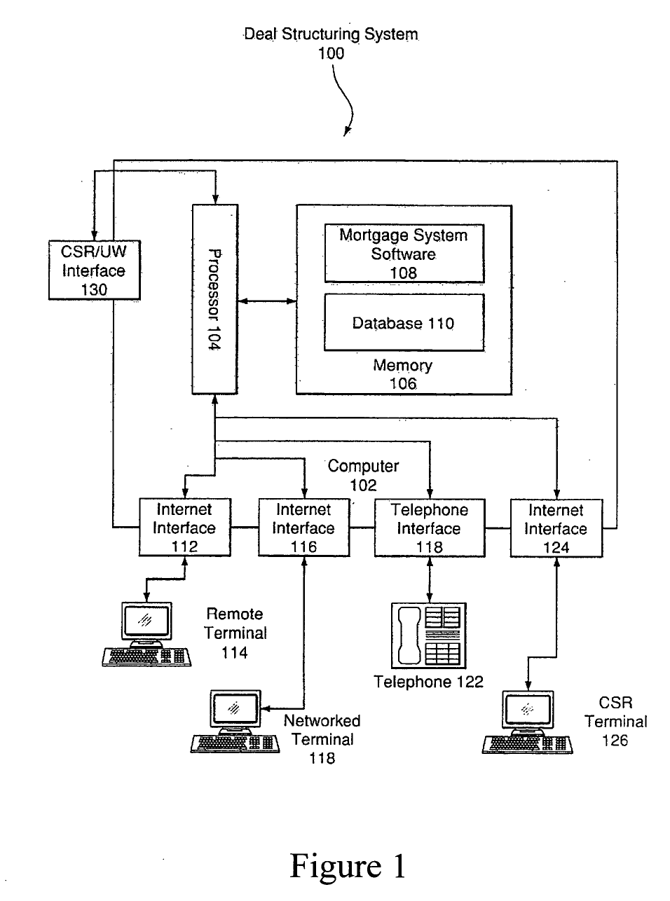

Referring now to FIG. 1, an embodiment of the present invention directed to automated process for deal structuring is illustrated. As shown in FIG. 1, a deal structure system (DSS) 100 includes a computer 102, which may be a mainframe computer, a minicomputer, a microcomputer, or other general purpose computing machine. The computer may include at least one processor 104 and a memory 106, which may be temporary memory, such as random access memory, permanent storage, such as a hard drive, or a combination of temporary memory and permanent storage. A Mortgage System Software 108 [hereinafter “MSS”] is stored in memory. Alternatively, MSS 108 may be stored on a removable computer readable medium, such as a CD-ROM (not shown).

Memory 106 may be used to store data regarding each deal structuring. This information may be stored in a database 110 within memory 106. Database 110 may be a database managed by a database management system, such as Informix, Oracle, or Sybase.

Computer 102 may have several interchanges, such as interfaces, for communicating with other entities. These interfaces include an internet interface 112 for communicating with customers 114 accessing DSS 100. Also, included is a network interface 116 allowing networked computers to access DSS 100. A network computer 118 may be located in a facility operated in conjunction with DSS 100, such that loan customers may access the system without having Internet access. The system may have a telephone interface 120, such that customers may dial into the system to access DSS 100. The system my have a customer service representative (CSR/BROKER) interface 122 so that salespeople 124 may access the system and utilize the automated processing of DSS system 100. Further, the system may include a remote interface, which allows a CSR/BROKER at a remote location to access DSS 100. The system may include a non-interface, which allows a CSR/BROKER to operate DSS 100 in stand-alone mode. In addition, DSS system 100 may include at least one third party interface, for third parties such as credit bureaus and third party loan offerors. DSS 100 may include an interface that invokes a CSR/BROKER or underwriter interface 130 (hereinbelow called the CSR/BROKER/UW interface) to become involved in a deal structuring when invoked by a customer. There may or may not be limitations placed on the invocation of the CSR/BROKER/UW interface, such as time limitations or multiplicity limitations, and the placement of such limitations on invocation will be understood to those skilled in the art.

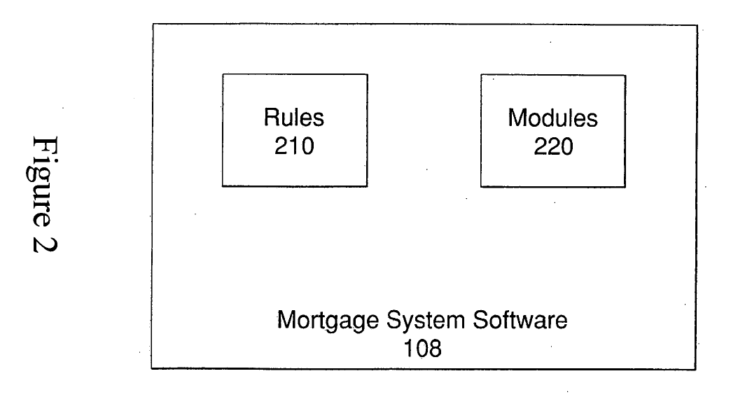

FIG. 2 illustrates an embodiment of MSS 108 of the present invention. MSS 108, resident on DSS 100, may include rules 210, and modules 220. An example of rules 210 may be own products exclusionary rules and third party, such as independent investors, exclusionary rules, for application to the information entered by a customer in a deal structuring. Another example of rules 210 may be pricing and risk rules, such as compensating factors rules, which provide rules for adjusting the eligibility of a customer based on ancillary factors such as time on a job, or disposable income, and such as repair rules regarding repairing LTV and DTI by changing customer preferences and recalculating the deal, and such as up-sell rules regarding the availability of greater loan amounts than requested by customer 114, and the applicability of offering such greater amounts to customer 114 for example. A further example of rules 210 may be edit preference rules including interactions for proposals and counter-proposals of varied customer deal preferences between customer 114 and DSS system 100 (for example, a customer may express a desire for a lower interest rate, which is countered by DSS 100 by requiring additional points at mortgage inception). MSS may include credit grading and credit transformation rules. Additionally, MSS 108 may include benefits rules, which identify the benefits of a specific product for a customer.

MSS may include explanation rules. Explanation rules are provided to bridge the gap between the deal, such as a loan, offered, and the deal customer 114 requested and/or expected. Explanation rules determine what explanation should be provided to a customer regarding an acceptance or refusal of, for example, the lender, to offer a product. The explanations provided are audience specific. For example, the explanations given directly, via a computer screen, to a customer in an internet based deal structuring, will be directed to a more inexperienced deal structuring audience, while the explanation provided to a CSR/BROKER to, in turn, be given to a customer, may be directed to a more experienced deal-structuring audience. Further, different explanations directed only to CSR's allow an offeror to prevent disclosure to the public, and, specifically, to competitor offerors, of, for example, underwriting and offering rules. Generation and storage of a explanations may provide an offeror with a record of reasons for deal refusal, should a customer later argue that refusal was improper, and may provide an offeror with a record of reasons for deal acceptances, thus helping to provide an empirical database of common reasons for acceptance and refusal.

MSS may include cross-selling rules. Cross-sold products may or may not relate to the deal requested by customer 114. Cross-sold products may include, for example, property and personal insurance, escrowing and loan payment direct deposit services, and services related to the acquisition of the new property, such as title abstracting and home inspection services. Whether or not to offer cross-sold products may depend on specific characteristics associated with each customer, or may depend on specific needs of each customer, which needs may be assessed through the preferences and choices entered by customer 114 to MSS.

MSS may include stipulation rules. Stipulations may include requirements to be met by customer 114 before the consummation of the deal, such as to consummate the loan. Stipulations may include, for example, that additional documentation be provided before a loan may be consummated, such as documentation of paychecks or bank accounts. Stipulation rules may include UW knowledge to recognize deficiencies in a deal, as well as general stipulations, and may be generated empirically by MSS as MSS develops a knowledge of stipulations generally necessary from every customer, or may be developed as an accumulation of outside materials, such as UW suggestions.

MSS 108 may include instruction modules 220 to allow for the saving of a deal structuring record before the entirety of necessary information, such as customer information, has been obtained. Thereby, a deal structuring may be saved, and returned to and accessed by the same customer, or a CSR/BROKER, for completion at a later point. The generation of security measures for preventing unauthorized access, by anyone other than the same customer, or by a CSR/BROKER, to the stored deal structuring, and retrieval of the stored deal structuring, may also be included in the “stop and save” instructions of MSS.

MSS 108 may include a “status check” module 220. Such a module may allow for the checking of status on certain elements of a deal, such as the status of certain stipulations required in a deal.

The description hereinabove is directed toward interaction between customers and DSS 100, and CSR's serving as intermediaries between customer 114 and DSS 100. A CSR/BROKER/UW module 220 of MSS may allow a CSR/BROKER to generate a loan deal structuring record for a customer, and access and edit the record, and may provide tools for assisting a customer in understanding the determinations generated by DSS system 100. Thus, although the same DSS 100 is accessed, the interface of customer 114, i.e. a deal structuring novice, or a competitor, or a partner, may be designed differently than the interface of the CSR/BROKER or UW with DSS 100, who possess greater expertise in deal structuring, and who may be authorized to access all or most information in the possession of the offeror with whom customer 114 is automatically processing the deal structuring, as discussed hereinabove.

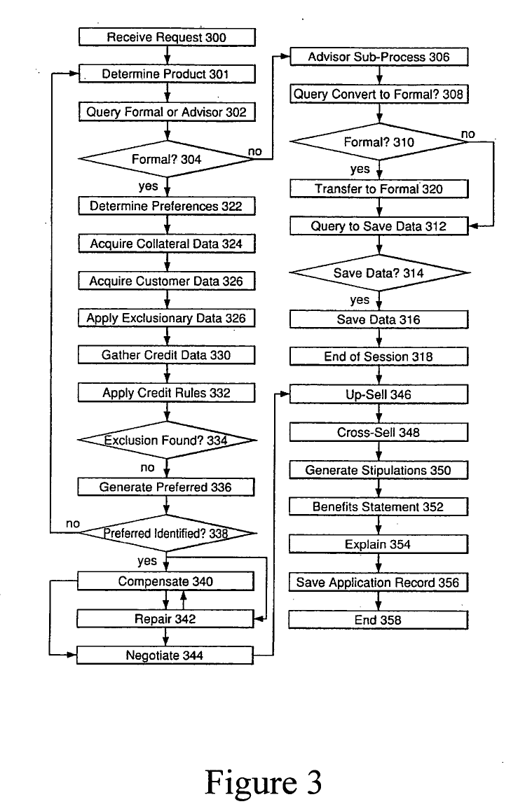

Referring now to FIG. 3, a method in accordance with the present invention is illustrated. The method first receives 300 a request from a customer for information regarding the offeror's products. Customer 114 is then queried 302 as to whether customer 114 may like to enter a formal deal structuring, or utilize a deal-structuring advisor, as discussed hereinbelow. If it is determined 304 that customer 114 may like to use the advisor, customer 114 is transferred to an advisor 306.

Advisor (“ELA”) 306 allows a customer to gain a better understanding of their financial needs, without incurring the requirements associated with formal deal structuring. Advisor 306 may be a MSS module 220, or may be a stand-alone program. Advisor 306 allows the entry of information, such as a social security number, and allows customers to evaluate options, and perhaps test eligibility, without having to disclose complete identity and/or large amounts of information. Finally, the information obtained during an advisor session may be transferred to the formal deal structuring process, with DSS system 100 querying for additional information in the formal process not gained in the advisor process.

Thus, ELA 306 may advise customer 114, based on limited information requested and received from customer 114, of the types and amounts of products which may likely be available to customer 114, if customer 114 chose to pursue a formal deal structuring. For example, ELA 306 may or may not request access to the users credit history, and, upon a request for access, may or may not generate a “hit” on the users credit history. For example, a loan generated by DSS 100 may include an automatic credit check of the borrower, and this automatic check may be performed in a manner that does not adversely affect the credit standing of the user. For example, in an embodiment wherein an agreement is arranged with a credit agency, multiple credit checks may not adversely affect the credit standing of the borrower, or may not be counted by that agency as “credit checks”. Thus the borrower may not be reluctant to use DSS multiple times, and may thereby have access to a further increased number of loan options. It will be apparent to those skilled in the art that any credit checking services of any loan product offered via a lender using DSS 100, in which a non-adverse credit checking agreement is desirable, may make use of the non-adverse credit check discussed hereinabove. Further ELA 306 may provide carry over, upon election of customer 114, to the formal process.

ELA 306 may be a web-based deal structuring implemented using Java technology, although other technologies may be used. It may be desired to utilize technology that allows the developer to mix HTML (static content) with Java code to produce dynamic content (HTML output). ELA 306 may use, for example, an Oracle database to store data entered by the user, to read in static data used to determine the advice text, and to populate dropdown list boxes. Thereby, data entered by customer 114 is stored after each screen by calling an Oracle package, for example. Whenever possible, the data requested from and given to customer 114 is stored in an existing loan origination database table within MSS 108. Data that has no corresponding storage location in the loan origination database is written to an ELA software table.

In an exemplary embodiment, the first page of ELA 306 might invite a user to enter a limited plurality of information, such as first name, and asks that the user choose one of at least four possible paths for the deal (refinance, debt consolidation, cash out and new home purchase, for example).

The first option second page may be called, for example, when the user selects refinance as the loan purpose. The first option second page reads all its deal structuring level data from the loan origination database the first time it is called. Upon this selection, ELA 306 may populate a series of drop down boxes, may store user data in the database, and may support logic, for example. The logic may include, for example, the calculation of an LTV, a DTI, and dynamic generation of advice messages (ELA recommendations). The second option second page is called, for example, when the user selects debt consolidation as the loan purpose. The second option second page may be implemented similarly to the first option second page, discussed hereinabove. The third option second page is called, for example, when the user selects cash out as the loan purpose. The third option second page is implemented similarly to the first option second page, discussed hereinabove. The fourth option second page is called, for example, when the user selects New Home Purchase as the loan purpose. If the user selects this option, ELA 306 may collect different information from the user than that collected in the first, second, or third option second pages. Upon this selection, ELA 306 may also populate a series of drop down boxes, may store user data in the database, and may support logic, for example. Further ELA 306 reads all its deal structuring level data from the loan origination database the first time it is called. The logic includes, for example, the calculation of the LTV, the DTI, and dynamic generation of advice messages (ELA recommendations).

Advisor 306 at the second, or a subsequent, page of ELA 306 may enter additional information, although this additional information must be entered before preparation of the final advice page. Such additional information may include, for example, number of liens, payoff existing on collateral, what to spend cash out on, years present home owned, fair market value of present home, current mortgage balance, purchase price, monthly income, and monthly debt.

The final page of ELA 306 may be the last step in an e-user interaction. This page may dynamically generate a recommendation given the information provided during the session. From this page, a user may enter a formal deal structuring via a hyperlink, for example. User data such as first name and generated data such loan id, address id and entity id are passed to the formal deal structuring, at MSS 108. ELA 306 may additionally include, for example, a calculator implemented as a standalone page that may be requested by the user to aid in calculations associated with ELA 306 process.

Upon completion of advisor 306, or, in the embodiment wherein a customer does not choose advisor 306, the system queries, at step 308, customer 114 as to whether he may like to enter a formal deal structuring. Step 310 determines that customer 114 may not like to enter a formal deal structuring, and thus step 312 presents customer 114 with the ability to save any entered data for later sessions. If it is determined at step 314 that customer 114 desires to save any entered information for later sessions, the information may be saved 316 with security provisions and the session may be ended 318. If it is determined 314 that customer 114 does not desire to have any information entered, the session may be ended 318. If it is determined 310 that customer 114 desires to switch to a formal deal structuring after the adviser session, the information may transferred 320 to the formal deal structuring process.

If it is determined 304 that customer 114 desires to enter a formal deal structuring, after, or without choosing, advisor 306, the system queries customer 114 to acquire 322 customer's 114 preferences. Table 1 provides a list of common elements related to a customer's desired preferences. Customer 114 is then queried to acquire 324 information regarding collateral with which customer 114 may secure the requested loan, and queried to acquire 326 information regarding the financial condition of customer 114. Table 2 shows a list of common elements related to the evaluation of potential collateral for securing an offered loan. The appraisal information for the proposed collateral may include estimates of appraised value of the collateral based on valuations for taxes, or recent transfers of similar properties, for example.

In addition to name and address information, the interface may prompt customer 114 to provide a taxpayer I.D. number, which for private citizens is generally a Social Security number. Table 3 lists a set of common elements related to the financial suitability of a customer for being offered a product. Once the requisite characteristics have been received from customer 114, the system may gather 328, with customer permission, credit history from a CRA, as well as collateral value information regarding the proposed collateral from a fourth source. A customer may grant permission to access the CRA by clicking an “Accept” button, or by assenting to a question from a CSR/BROKER, for example. Further, the standardizing of the credit data may include credit grading and transforming.

This information is then processed by DSS 100 to form 330 a deal structuring record for the deal structuring process. The deal structuring record is contained in a database 106 to allow access to the data by DSS system 100, including access for CSR's or UWs who require access to the data to evaluate product offerings. Forming the record also generates standardized parameters for the deal structuring, such as maximum allowable loan-to-value (LTV) and debt-to-income (DTI) ratios. The combined preferred parameters, potential collateral data, customer suitability information, credit history, and collateral appraisal information may then be joined to form a deal structuring record.

Once the deal structuring record has been completed, exclusionary rules may be iteratively applied 332 to the deal structuring record to determine whether offering a product to customer 114 should be excluded based on the contents of the record. Exclusionary rules are discussed hereinabove, and may include exclusions based on the location of the potential collateral, or the credit history of the borrower, for example. Table 4 lists several collateral and credit history exclusionary rules for illustrative purposes. Exclusionary rules are iteratively applied, with the offeror's exclusionary rules being applied first, then MSS looping through a processing of all rules with respect to the offeror, and then a second iteration with respect to a first third party offeror, and then rules with respect to that first third party offeror, and then a third iteration using a second third party offeror, and so on. In an embodiment, the iterative loop is performed only with respect to the exclusionary rules, and then the iterative loop is repeated using the rules of all parties not excluded by the exclusionary rules. Thus, the present invention offers application of unique rules for each of numerous lenders in an iterative rule application.

In an embodiment of the present invention, application of exclusionary rules to the deal structuring record is accomplished by MSS 108 using an inference engine 206. The application of exclusionary rules may be accomplished by numerous other methods, which methods will be apparent to those skilled in the art. Based on the information in the deal structuring record, inference engine 206 applies rules based on the likelihood of applicability. For example, if the property type of the potential collateral is “single family detached residence”, inference engine 206 may apply rules based on residential properties before applying rules based on commercial use concerns.

Once it has been determined 334 that no exclusionary rules bar the offer of a product to customer 114, with respect to at least one possible offeror, UW rules may be applied to the deal structuring record to determine whether a deal characterized by customer's 114 requested parameters may be offered to customer 114. It will be apparent to those skilled in the art that a credit grading and transformation, such as downgrading the credit grade based on bankruptcy, foreclosure, or public records, may be necessary to allow the application of certain of either the exclusionary rules of the offeror or third party offerors, or of the UW rules of the offeror or a third party offeror. UW rule process may be iteratively applied. UW rules may be applied in turn for each possible offeror following the exclusionary rules of that offeror, or may be applied only after global application of all exclusionary rules. UW rule process may involve identification 336 of one or more preferred products that may be suitable for customer 114. Different product types may be characterized by different product characteristics, such as shorter duration deals having lower interest rates, and longer duration deals having higher interest rates, for example. Further, interest rates also tend to vary from property type to property type, and according to credit rating, and as a function of the LTV ratio, for example.

A preferred option may be generated at step 336, through UW rules process. As used herein, “preferred option” includes the options that meet the preferences of customer 114 or the user. A preferred loan option is generated 336 by selecting from the offeror's available product types those products whose rules are satisfied by the elements stored in the deal structuring record. Each product type, of the offeror and third party offeror or offerors, may be considered an option for meeting customer's 114 preferences request. Each product type option is examined to determine if the elements in the deal structuring record meet the specific requirements of the product type. For example, if a customer's preferred request is for an amount more than an option's maximum product amount or less than an option's minimum product amount, that option may be disqualified, compensated, or repaired, as discussed hereinbelow. As another example, if the preferred request is characterized by a loan to value (LTV) ratio greater than an option's maximum allowable LTV ratio, the option may be disqualified, compensated, or repaired. Options may also be disqualified if the property type for which the deal is requested differs from the property types for which the option is available, or if the occupancy range of a preferred request differs from the allowable occupancy range of that option. Other factors which might disqualify options might include credit grades differing from the allowable range for the option, differing input documentation level from that allowable for the option, and/or differing lien positions from those allowable for the option, for example. If more than one option is applicable for meeting customer's 114 preferred request, the remaining options may be prioritized. Prioritization may be selected by the offeror or offerors, or by customer 114 by clicking a “Sort by” tab or icon, for example, and may be done by many priorities that will be apparent to those skilled in the art, such as, but not limited to, monthly savings, lowest lien position, etc. If only one option remained applicable after each factor has considered, then that option is the preferred option. Once the preferred option, or hierarchy of options, has been identified, the terms of the option or options are recorded for association with the deal structuring record, and the preferred request is completed.

If no preferred options are identified following this procedure, pricing and/or risk rules, such as compensating rules 330 and/or repair rules 332, may be applied to attempt to gain an option that is acceptable to the offeror or offerors.

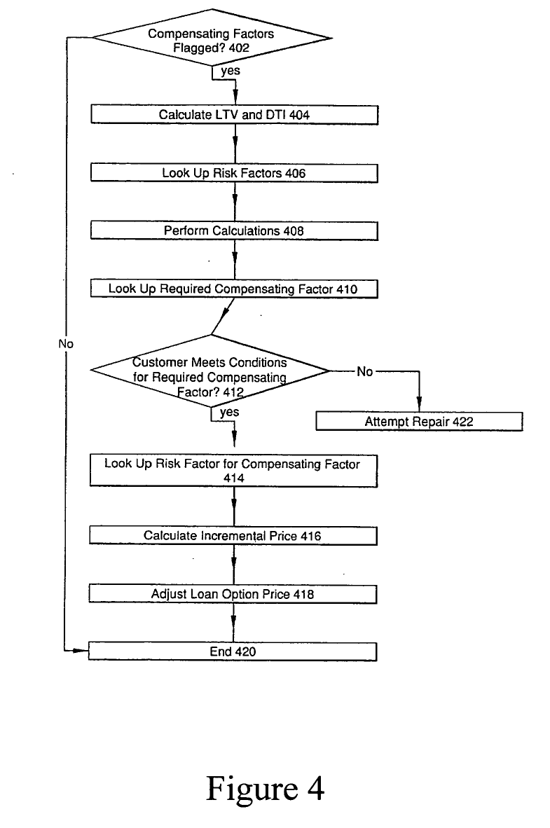

Compensating rules are provided in MSS to offset conditions that fall outside of the offeror's, or offerors', guidelines. An overview of the compensation process may be seen in FIG. 4. The application of compensating factors may enable customer 114 to qualify for a product although, for example, customer's 114 DTI is excessively high. A compensating factor is essentially a tradeoff to compensate the offeror for the increased risk, thus providing flexibility for the offeror when the qualifications of a customer do not meet the requirements of a offeror's, or the offerors', products. The use of compensating factors enables the offeror to override the requirements of a product in an attempt to offer a modified option, rather than a preferred option, to customer 114, rather than not offering any option. In some cases, the application of compensating factors may result in additional risk to the offeror that may be offset by increasing the price, such as an increase in the interest rate.

Compensating factors may be applied under three conditions: the product amount is greater than the maximum allowable product amount and less than or equal to the marginal amounts over the standard maximum; the LTV is greater than the maximum LTV and less than or equal to the marginal amounts over the standard maximum LTV; and/or the DTI is greater than the maximum DTI and less than or equal to the marginal amounts over the standard maximum DTI. For example, the standard maximum DTI might be 50%, but the marginal amounts over the standard maximum DTI might be 55% for a particular product. If a generated option is one wherein one or more of the product amount, LTV and DTI exceed the respective standard maximums, but are less than the marginal amounts over the standard maximums, the generated option is flagged for the application of compensating factors. In such an instance, the compensating factors are applied to re-price the generated option in order to compensate for the increased risk.

The incremental price, expressed in basis points added to the interest rate of the preferred mortgage loan option, is calculated based, in part, on the risk factors for documentation type, property type, mortgage loan amount, lien factors, occupancy type, credit grade, and compensating factors, for example. Risk factors are then generated from a MSS look-up table that associates a risk with each documentation type, property type, mortgage loan amount, lien factor, occupancy type, credit grade, and compensating factor, for example.

A customer must then fall within a predetermined total maximum risk in order to receive a compensated product option. Following a calculation of customer's 114 predicted post-deal disposable income and savings, using formulas known in the art, MSS looks up the required compensating factor. The compensating factors may be defined, for example, for a specific combination of Credit Grade, Documentation Type and Property Type, or for a specific total risk value.

Customer 114 is then tested to assess whether customer 114 meets the conditions to have the required compensating factor applied to the deal. The manner of formulating these types of tests used will be apparent to those skilled in the art. If customer 114 fails the corresponding test, it indicates that customer 114 does not qualify to have the required compensating factors applied to the deal, and that the price of that option cannot be compensated to account for the increased risk with respect to that customer.

If customer 114 passes the above-referenced test or tests, an incremental price may then be calculated by weighting each of the four mortgage loan attributes mentioned above, and then applying a formula multiplying the risk factor by the weight of each factor including a risk, and multiplying that total by a pricing factor. The option is then adjusted for price by the amount of the incremental price.

It will be apparent to those skilled in the art that other loan attributes could be compensated for increased risk, such as length of time in a residence, or the length of time in a current job, for example. Those loan attributes may be compensated in substantially the same manner as the attributes discussed above.

Additionally, the repair and compensation steps of the present invention may be performed alone, or in conjunction. For example, a customer may receive one or more options based on repair, and one or more loan options based on compensation. Further, a customer may receive one or more options that are both repaired and compensated. The factors used in both the repair and/or the compensation rules may be the same or similar factors, and the rating of risk process may be the same or similar in both the repair and compensation modes, either alone or in combination.

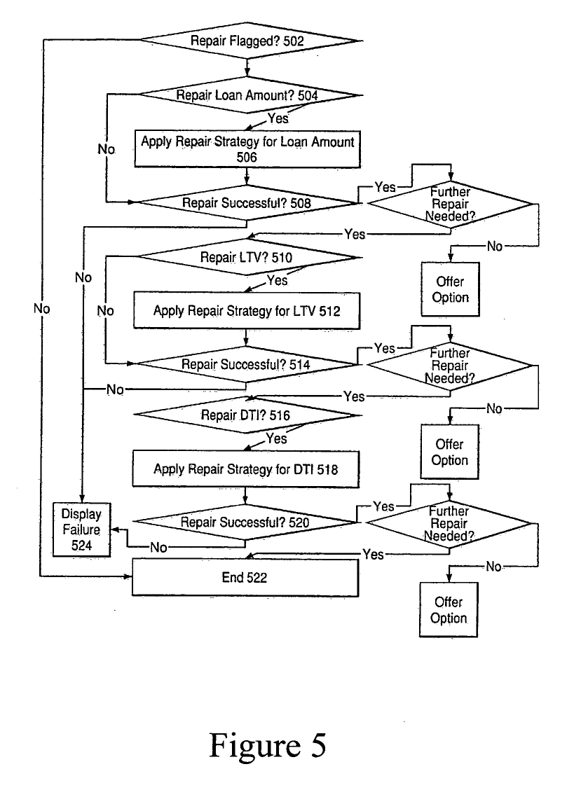

Repair rules may be included in MSS, and are used to execute repair strategies to modify the preferences specified by a customer, to thereby allow customer 114, who might otherwise not qualify, to qualify for a product. An over view of the repair process may be seen in FIG. 5. The repair overrides customer's 114 preferences in an attempt by MSS to offer a modified option to the applicant. Where applicable, the application of repair may enable the offeror to generate an option, such as a sub-prime mortgage option, to a customer, even if the original customer preferred request failed to meet the offeror's original program and/or credit guidelines. Such failures might include, for example, a customer requesting an option having an above-allowable DTI for that customer, an above-allowable LTV for that customer, a longer than-allowable term for that customer, or a loan request or cash out request in excess of that allowed to a particular customer under the offeror's requirements for that customer. Repair rules may be invoked, for example, when an attempt at compensation has failed.

Repair may be performed where a preferred option is not generated. Customer 114 request may then be flagged for repair. In particular, if the requested attributes deviate from the requirements of the product identified as preferred the specific areas of deviation may be flagged for repair. Following the flagging, repair rules are applied to modify customer's 114 specified preferences in an attempt to conform the request to at least the LTV, DTI and amount tolerances within the limits allowed by the offeror. Repairs may be attempted in the sequence in which they were flagged for repair. For example, if the LTV and DTI are flagged, MSS may always attempt to repair the LTV, followed by an attempt to repair the DTI.

Repair strategies may be followed for the repair of LTV, DTI, and loan amount as will be apparent to those skilled in the art. For example, if the amount specified by customer 114 is higher than the product requested, and, for example, the deal purpose is specified as to receive cash out, then the “decrease debts to pay off ” repair strategy may be applied, wherein the debts that were specified by customer 114 as “debts borrower may like to pay off” are modified to “debts borrower may not like to pay off,” starting with the debt with the largest balance. With each such modification, the deal amount is reduced, until the amount no longer exceeds that of the generated option. The repair strategy is executed until it succeeds in meeting the requirement of the generated option, or until it exhausts all possible modifications. As a further example, if the deal purpose is debt consolidation, then the “Decrease cash out” strategy may be executed first. As the cash out is decreased, the loan amount and LTV decreases. If the LTV still fails to satisfy the required LTV of the loan product even after all of customer 114's specified cash out has been eliminated, then the subsequent strategy of “Decrease debts to pay off” is executed, and so on. The repair strategies are executed sequentially until it succeeds in meeting the required LTV of the product, or until it exhausts all LTV repair strategies. As an additional example of repair, with respect to DTI, if the deal purpose is cash out, then the “Extend term” strategy is executed first. As the term of the deal, such as a mortgage loan, is increased, the monthly payment and the DTI inherently decrease. If the DTI still fails to satisfy the required DTI of the product, even after the term has been extended to its maximum (generally 30 years), then the subsequent strategy of “Increase mortgage loan amount to pay off more debt” is executed, and so on.

Other repair strategies, in addition to that discussed hereinabove, will be apparent to those skilled in the art from the examples shown. Further, in an embodiment, the application of repairs may be performed subsequent to the application of compensating factors, but repair may also be performed before, in conjunction with, or entirely without compensation. Additionally, it will be apparent to those skilled in the art that, over time, an empirical database of compensation and/or repair strategies implemented, successful, and failed may be built, and, following the building of the empirical compensation and/or repair database, an empirical database score may replace the assignment of factors as discussed hereinabove, thus generating true risk-based pricing.

Returning now to FIG. 3, customer 114 may enter into edit preference 334 with the offeror through DSS system 100. Editing preferences may include a customer proposing edited preferences to DSS system 100 to modify parameters, in conjunction with DSS system 100 responding whether or not the edited preference option is acceptable. The edit preference rules may additionally respond to customer 114 with a counter-proposal. The edit preferences rules may additionally entail the inclusion of compensation and repair in the attempt to accept customer 114 generated modified option of the edited preference.

Where a preferred, compensated, or edited preference option for the deal is accepted by the offeror or offerors, DSS system 100 may then generate 346 up-sell options to customer 114. An upsell is generated because it is often the case that a customer, i.e. a potential borrower, does not possess adequate knowledge the optimized, or nearly optimized, loan amount for which that customer may be eligible. Customer 114 will often qualify for a larger cash value than requested, and, if customer 114 may participate in a deal for a larger value than customer 114 had requested, both customer 114 and the offeror may benefit in the manner known to those skilled in the art. Thus, it may be preferable to automatically generate up-sell options in addition to any preferred, compensated, or preference edited option. An up-sell option is an option with an amount higher than that requested in the preferred option. An upsell is generally attempted if one product option generated is that of the primary offeror, i.e. the maintainer or owner of MSS, for example, but an upsell may not be attempted if the options generated pertain only to third party offerors, for example, at the option of the primary offeror.

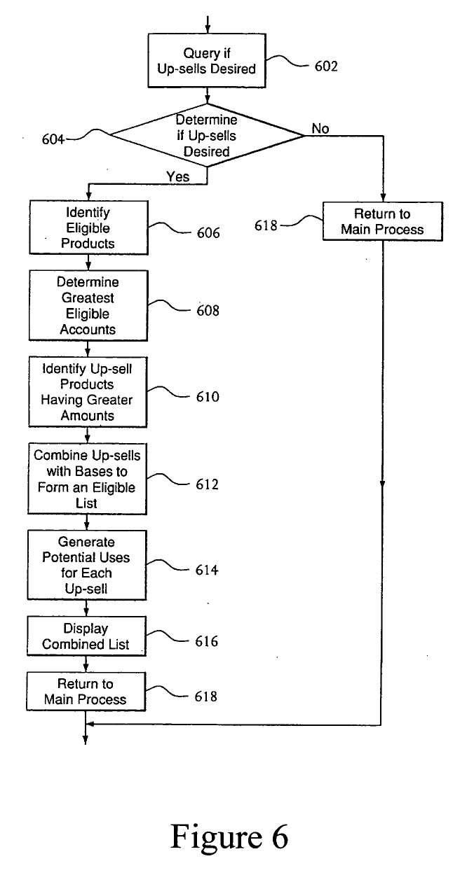

As shown in FIG. 6, the up-sell may query 602 customer 114 to ascertain if customer 114 is willing to consider up-sell options. Customer 114 is not queried, and up-sell is generated automatically. For the eligible products, DSS 100 determines 608 incrementally larger amounts for which customer 114 may be eligible by applying upsell strategies and rules discussed hereinabove. For example, DSS may query whether customer 114 could receive an additional $5,000 and remain within the guidelines of any offeror or offerors (which is individual assessed with respect to each remaining offeror), and, if customer 114 is still within the guidelines of at least one offeror, DSS may add an additional $5,000, and repeat the iterative process. DSS 100 may additionally generate a list of potential uses for the excess value of each up-sell loan option. For example, where the amount is inadequate to pay off an existing liability, the excess value may be offered as cash, but where an existing lien exists on the property, the potential usage may be to pay off the liability associated with the lien. If customer 114 does not have any outstanding debts, up-sell recommendation rules may be provided in MSS 108 so that the recommendations to customer 114 may be based on customer's 114 background information, as obtained during the deal structuring.

Once the list of potential uses has been generated for each up-sell product, a list of the up-sell product or products, and of the preferred, compensated, or preference edited products is generated and displayed to customer 114.

Once a list of options has or has not been determined, DSS system 100 may provide an explanation 366 of the results. If a customer is excluded from being offered a specific deal, or if customer 114 does not understand why another product was selected as the preferred option (i.e. if a repair or compensation took place, for example), the implementation of an explanation function may provide customer 114 with a heightened understanding of the deal structuring process. The target audience may be distinguished when providing explanations. In such an embodiment, the specific explanations provided need to be customized to presumed knowledge, based on whether the audience is a customer or a professional, such as a CSR/BROKER. Further, for business reasons, certain information for internal use only may be provided to the CSR/BROKER, but not to customer 114. Thus, a separate set of explanation rules may be provided in MSS 108 for transforming the rules unto an understandable format for a customer. The explanation rules serve three purposes: to translate the rules into a form understandable to the recipient of the list; to ensure that the list does not improperly disclose proprietary information; and to reduce the size of the explanation by removing from the list rule outcomes that did not affect the determination. Generation of an explanation list may be based on the expert engine noting the rules applied, and the outcome of those rules.

As an example, consider an Exclusionary Rule as follows:

IF (Property Address is one of a set of Excluded States) THEN (bypass mortgage loan option generation).

To create an explanation list, the above rule is modified to include the generation of an explanation text, as shown below.

IF (Property Address is in one of a set of Excluded States) THEN (bypass mortgage loan option generation) AND (generate explanation “We're sorry, but currently we do not grant loans in the state of: STATE.”)

The actual state where the property is located is substituted for the: STATE variable in the explanation text, for example. Generated explanations are stored in an explanation table until an explanation list is generated from the stored table, as described further hereinbelow.

Other examples of explanation text might include: “The loan amount is above the maximum allowable,” and “The DTI ratio is too high for the loan to be approved.”

These examples provide a conceptual description of how rules are applied in the present invention. However, in order to flexibly and efficiently implement the capability to generate explanations, data driven methods may be employed. In short, a Create Explanation procedure may be used by each rule to populate an EXPLANATIONS table in the database. Further, other tables stored in the database may also be referenced. A Create Explanation procedure may be called by any of the rules from within one of the sub-processes in DSS. The EXPLANATIONS table is dynamically populated with each execution of the Create Explanation procedure. Thus, this table grows larger as the deal structuring process is executed. Ultimately, this table may be used to generate an explanation list. An EXPLANATION TEXT table then associates each explanation text identifier with an explanation name, explanation text and other related information. This table is created when the system is constructed. Further, an AUDIENCE table enables explanations to be tailored based on factors such as the audience's level of knowledge (e.g., beginner, intermediate or advanced), the audience's function (e.g., loan officer, broker, analyst, underwriter), and the like. For example, a system engineer audience may be defined, and extremely detailed explanations may be generated for that audience for the purpose of auditing and debugging the system. To generate an EXPLANATIONS display, the EXPLANATIONS table is sorted and filtered to extract only those explanations directed to the AUDIENCE for whom the display is being generated. The result of the sorting and filtering is the explanation list, which contains all of the explanations generated for the intended audience in chronological order.

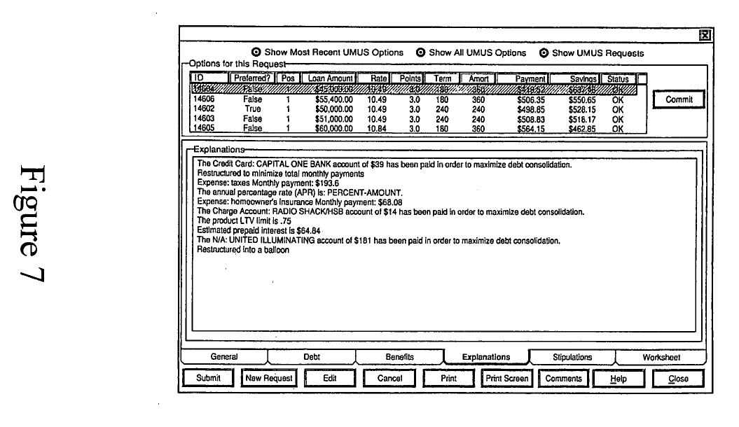

FIG. 7 shows an example of an explanation list displayed by user interface. When a loan is selected by highlighting 802 the specific loan from among the products listed, and the “Explanation” tab is selected 804, the explanations associated with the loan product may be displayed 806.

Upon completion of the generation of the list of options available to customer 114, the benefits available through each, or all, of the options are presented to or made available to customer 114. From the perspective of a customer, the presentation of the benefits helps him or her better understand the various advantages to be gained from a particular option. If customer 114 is presented with at least one up-sell option, customer 114 may be presented with an explanation of why an up-sell may benefit customer 114, thereby helping to increase the number of customers that choose an up-sell option, which upsell option also benefits the offeror. At least one of the benefits presented is individualized to each unique customer. The manner in which benefits may be individualized from entered customer preferences will be apparent to those skilled in the art.

Presentation of benefits may be of particular importance in the sub-prime deal market. In the sub-prime market, the decision that a customer makes may be based more on the benefits of a particular option, because a sub-prime borrower generally cannot obtain all desired preferences of that customer, due to that customer's financial profile. Thus, if a customer finds that, for example, a first offeror offers a $50,000 loan for $610 per month, and a second offeror offers the same mortgage loan for $605 per month, customer 114 may generally select the second offeror. However, if the first offeror also offers benefits, such as monthly automatic withdrawal of the payment from a checking account, and/or saves customer 114 $200 in monthly debt payments, due to the payment of other debts, then the potential borrower may select the first offeror based on the explanation of these benefits.

In general, there are two types of benefits that may be associated with products. There are default benefits that apply to all loan products, and individualized benefits, which may or may not apply, based on the specifics of the product and deal structuring information. Default benefits include, for example, automatic deduction of payments from a customer's bank accounts, or not having to make a payment within the first month after closing. Individual benefits include, for example, lowered overall monthly debt from $790 to $695 due to a rolling of existing debts into a single payment product.

The generation of a benefits statement may be performed using an application of benefit rules to the information contained in the deal structuring. Exemplary benefits rules are provided in Table 21. As an example of the application of benefit rules, if a portion of the product could being used to pay off outstanding debts, the application of benefits rules may determine that the number of outstanding payments was being decreased by three. From this, DSS may inform customer 114 that the product may reduce customer 114's number of monthly payments from four to one.

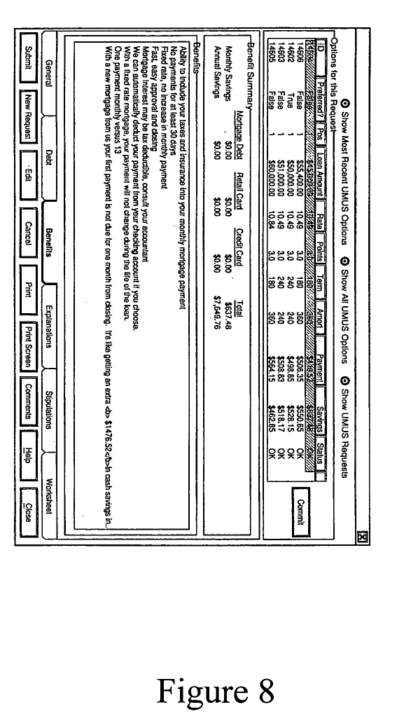

FIG. 8 shows the screen interface of a benefits display. A benefits window is shown below a display of a plurality of product options. The benefits window is activated by selecting the benefits tab 902 near the bottom of the display. When a product is selected 904, the line entry for the product is highlighted, and the benefits information for that individual loan product may be displayed 906 in the benefits window.

At various points throughout the deal structuring process, products not requested by customer 114 may be cross sold 364. DSS 100 system may, for example, maintain a database of products and services, the availability of which may minimize customer 114's efforts required to complete the planned deal, or to complete an additional deal. Examples of such services may include title insurance and abstracting services, referrals for home inspections, and insurance services for the collateral.

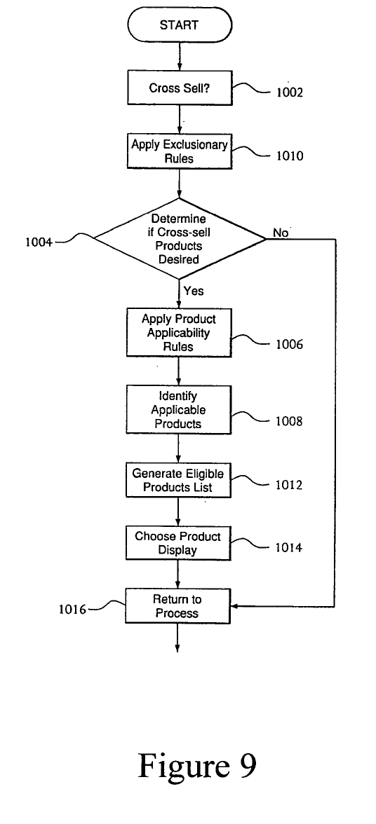

The cross selling of products is shown generically in FIG. 3 as block 364. FIG. 9 shows the process in greater detail. Once it has been determined that customer 114 is eligible to receive a deal option, the system may query 1002 customer 114 whether customer 114 desires to be offered products and services related to the requested deal structuring, or the system may offer such additional products without querying customer 114. DSS 100 then applies 1006 product applicability rules to the products listed in the database of products and services to identify 1008 applicable products and/or services for cross selling to customer 114. For example, if customer 114 is purchasing a new construction home, the services of a termite inspector are likely not needed, and should not be offered. If information in the deal structuring discloses that customer 114 will make a long-distance move to occupy the new property, DSS system 100 might offer insurance for the goods in transit.

The database of products and/or services may be generated by arranging referral agreements with providers of goods and services. Alternately, products may be included in the database based on a per display fee, such that each time the product is offered to a customer, the offeror is compensated by a fee whether or not the product is chosen. Agreements may also be made between the offeror and the related service provider, wherein the offeror receives a percentage of the service provider's revenue from services actually procured by customer 114.

Once a list of applicable products from the database has been identified 1008, DSS 100 may apply 1010 exclusionary rules associated with the products and/or services, to ensure that products for which customer 114 is ineligible are not offered to customer 114. For example, a title insurance company may limit the territory, for which they will write policies, requiring exclusionary rules to prevent that company's title insurance from being offered to a customer who does not reside in the territory. Once the exclusionary rules have been applied to the cross-sell products and/or services, a list of eligible products and/or services is generated 1012 by identifying the products that are both applicable to customer 114, and for which customer 114 is eligible based on the exclusionary rules. This list may be displayed to customer 114, allowing customer 114 to select services as desired. Where the cross-sell information is presented to customer 114 via the Internet, a more robust version of the above process may generate products and/or services requests to providers chosen by customer 114 by hyperlink, for example, as well as by ordering through the offeror. It will be apparent to those skilled in the art that certain reporting tools may be used in conjunction with the present invention, and, specifically, with the cross-sell aspects of the present invention. For example, the data generated in the process of the present invention may be used to generate sales leads for sale to third parties, and may allow for tracking of the results of, for example, advertising.

Additionally, throughout the above referenced process, customers may desire to interrupt the process to acquire more information or to accommodate other time restrictions. In order to accommodate such demands, DSS system 100 allows a customer to interrupt the deal structuring procedure, save the data entered to that point, and, at a later point using applicable security precautions, to restart the deal structuring process from the point at which customer 114 interrupted the procedure. This stop and save procedure may also be invoked from within the advisor module, allowing a customer to break an advisory session into a plurality of sessions.

Certain situations within the deal structuring process may be designated in DSS for underwriter involvement, and, alternatively, a customer may not understand particular points in the deal structuring process, and thus may have questions that he or she feels need to be answered before the deal structuring process may continue. Although “help” information may be provided by DSS for basic questions, customer 114 may not feel that their concerns are adequately resolved by the “help” information.

DSS system 100 thus incorporates a CSR/BROKER/UW Invocation interface, which allows a customer of DSS system 100 to invoke a CSR/BROKER/UW into the deal structuring process. The involvement may be through a pop-up window allowing text messaging, a telephonic contact, or may involve referencing of the CSR/BROKER/UW to provide options or approvals for a situation outside of MSS rules. Alternatively, the CSR/BROKER/UW may be invoked to manually conduct repair or compensation of loans that do not meet the standard criteria associated with DSS system 100, as discussed hereinabove.

In an embodiment of the present invention wherein a preferred loan option may not initially be available from DSS 100, DSS 100 or a call to the CSR/BROKER/UW, may operate to generate a piggyback loan option. Piggyback loans are an example of loan options that may be suggested to a borrower when the borrower's loan to value ratio (LTV) is too high to qualify for a second position security interest in collateral, such as real estate. In order to meet customer 114's request, it is preferred that the lender assume the first security or lien mortgage position in a primary loan, up to 80% LTV. The lender may then offer the complementary second position loan customer 114 was requesting for up to the remaining 20% LTV, or may offer more if there are investor products available that cover over 100% LTV.

It is generally desirable that, in an embodiment wherein a piggyback loan is selected, both loans of the piggyback close simultaneously, and such a statement may be included, for example, in the explanations or stipulations. A complementary secondary loan need not be valued to reach the exact difference between the full desired loan value and the primary loan. A complementary secondary loan may be valued at a lower or higher amount than that required to make up the full 100% LTV.

The structure of a piggyback loan may be dependent upon certain deal preferences chosen in the first loan, in light of the fact that both loans are being used to meet one overall financial standing for one customer. For example, all debt information is shared as between both loans, but a given debt may be paid off in only one of the loans (i.e. the first loan). Further, a piggyback loan or loans may be offered as upsell or deal repair alternatives by the DSS when deal structuring. An upsell is a condition where the lender may offer a product that has greater value than that which was initially desired by customer 114. In an embodiment wherein a piggyback loan is committed into MSS, the relationship between the two or more loans of the piggyback loan is captured as well. For example, the amount of the second lien may be calculated to be equal to the negative proceeds on the first loan, such that customer 114's cash-out preference may be covered in the first loan, wherein a cash-out is a customer preference to borrow cash against the security of the collateral under consideration. The relationship between the first loan, the second loan, and customer 114 preferences, such as a cash-out, are often complex and dependent upon many different factors, and thus the need arises to automatically maintain the synchronization between the loans as they are being structured for customer 114 within MSS. This synchronization allows the effect of changes to one loan to be accurately perceived in the second loan.

Certain loans provide additional opportunity for an upsell. For example, a customer may ask for a second lien position and then may be offered an up-sell to a first lien position, plus at least one investor product piggyback for a second lien position. Thus, in some instances, rather than providing a small loan as a second lien (often an investor product), an option may enable a lender to take a higher value first position loan. This creates more options for customer 114 and greater opportunity for the lender. Certain loans may additionally repair an otherwise unacceptable LTV ratio if a customer requests a loan whose value is 80 to 90% of the value of the preferred collateral. Additionally, more options are available to customer 114 wherein a these certain loans are offered, because these loan options may be restructured by editing, within DSS, either the first or second lien loan to accommodate a preference by customer 114.

In an embodiment of these additional loan types, a piggyback loan amount includes two components, in the ratio of 80/20 to account for price breaks. This ratio of the LTV of the first loan to the second loan is parameterized, and may be adjusted in DSS. Additionally, the piggyback is not forced to be 100% LTV and may be varied by the user. The first loan may, for example, pay off all customer 114 debts. In the instance wherein all the debts for the second loan are being paid off by the first loan, the payoff of the second loan debts using the first loan is ignored for the purpose of assessing which product is available for the second lien position loan. Further, in the absence of specific inputs by either a customer or a CSR/BROKER, selected default terms, such as loan term duration, may be set to 15 or 30 years, or as balloons, for both the master first loan and the piggy back second loan.

A procedure for determining a loan that is not forced to be 100% of the LTV, wherein the loan corrects a customer problem that the LTV is larger than the largest LTV product for the first lien loan problem, is illustrated as follows:

1. Calculate 80% (parameter) of the value of the house;

2. Use value from (1) as a loan amount preference and solve for amount available for the first position lien loan value, subtracting out points and fees;

3. Decide which customer debts to pay off and which to not pay off;

4. The difference between loan amount available and total required (debt plus cash-out) may be a negative number indicating the amount necessary for the loan (this becomes cash-out preference for the second loan amount). This second loan amount does not include points and fees on the second loan;

5. Use MSS resources to find a first product for this amount. Do not repair it;

6. Calculate the monthly payment for the first loan;

7. Select a Product for the second loan. Add in points and fees for the second lien. This becomes the total loan amount for the second lien. Do not repair the second loan;

8. Calculate payment on the second loan;

9. Calculate one DTI for both loans, including all unpaid debt, monthly payment for both, taxes and insurance;

10. Check to see that the DTI is within limits of the two products.

An exemplary procedure for an LTV repair is as follows:

1. Find highest LTV Product for customer 114;

2. Subtract points and fees to determine second loan amount;

3. Provide the amount by which to reduce cash or debt;

4. Based on customer's purpose for the loan, start with either cash or debt;

5. If cash is the purpose, it is taken out of the cash-out of the second loan;

6. If reducing debt is the purpose, then mark the first, and correspondingly reduce the negative cash-out number on the first.

A procedure for a DTI repair is as follows:

1. Determine if the DTI problem is either on first, second, or both loan options;

2. Determine which product has lower requirement. That product will drive the amount by which the DTI needs to be lowered;

3. Pay off debts (if customer's purpose is cash) by increasing loan amount on second loan, and determine LTV limit and calculate the amount of cash that may be added. Use that amount to pay off debts;

4. Pay off debts from cash (if customer's purpose is debt reduction) by reducing the cash-out on the first loan, and pay off debts using the first loan. Negative number used for second loan will remain the same;

5. Reduce cash (second repair option for both purposes) by reducing cash-out on second loan. Therefore the second loan amount goes down and negative cash-out on first loan is recalculated.

In an embodiment of the present invention, additional upsell loans may also be generated. An difference between this option and other loan options previously discussed may be that the negative amount calculated from the first loan is not used to determine the size of the second loan, but rather is used only to ensure that the preferred debt pay-offs and cash-out are within allowable limits. The amount of the second loan is determined by the 20% of necessary loan value remaining, assuming an 80% loan parameter is used for the first loan. A procedure for generating an Up-sell loan, wherein the loan is forced to 100% of LTV is as follows:

1. Calculate 80% of the value of the collateral;

2. Use amount from (1) as a loan amount preference, and solve for amount available, or first loan amount, subtracting out points and fees;

3. Decide which debts to pay off and which not;

4. Calculate loan amount for second loan by using 20% and subtracting points and fees;

5. Find a first loan product for this amount. Do not repair it;

6. Calculate the monthly payment for the first loan;

7. The difference between loan amount available for the first and total required (debt plus cash-out) may be a negative number signifying the amount necessary for the second loan (that amount does not include points and fees on the second loan amount);

8. Select a Product for the second loan. Do not repair the second loan. If the difference is greater than amount calculated allowable for the second loan, then the deal fails;

9. Calculate payment on the second loan;

10. Calculate one DTI for both loans, including all unpaid debt, monthly payment for both, taxes and insurance;

11. Check to see that DTI is within limits of the 2 products.

In an embodiment, constraints may be placed on portions of the DSS. For example, although the loan terms for the two loans may be different, the loan term for the second loan should not exceed the loan term for the first loan. To that end, the DSS employs the specific product guidelines as specified in the product sheets. If DSS cannot find both a direct lender product for the first position loan, and a product for the second position loan, then the deal may not be offered to customer 114. Note that DSS may search for a product for the second loan.

After customer 114, or the CSR/BROKER, has selected which of the options in a deal is desired, the selected deal may be committed and submitted in MSS and, documentation requirements are provided and a closing date scheduled.

In addition to providing customer 114 with multiple loan options, the present invention may add a reduced term option for customer 114. In the case of a mortgage, these reduced term options may be identified to the consumer as beneficial, such as by way of an explanation, by a showing of the savings that the shorter mortgage term may supply. For example, if customer 114 had ten years remaining at $800 a month, and the reduced term offer may be for five years at $1500 a month, the client may save $6,000. This is calculated as ($800* 120 months)−($1500*60 months).

The reduced term loan may be generated for customer 114 for multiple fixed loan duration, in order to provide customer 114 with multiple reduced term options along with the cited savings. For example, the reduced term fixed loan may be generated with a term remaining at less than the remaining term on customer 114's current product. In addition, the reduced term loan offer may be applied when a candidate customer has achieved some equity in the collateral, or when customer 114 has a preferentially low debt to income ratio.

A calculation of a reduced term loan strategy might first include a calculation of surplus equity in the collateral as follows:

| | | | | |
|---|---|---|---|---|
| Lendable equity | | | $100,000 | |
| Balance on collateral | $50,000 | | | |
| property's first mortgage | | | | |
| Balance on collateral | $10,000 | | | |
| property's second | | | | |
| mortgage | | | | |
| (if any) | | | | |
| Total other debt balance | +$10,000 | | | |
| Total balance | | $70,000 | | |
| Closing costs | | +$2,100 | | |
| Total debt | | | − | |
| | | | $72,100 | |
| Surplus Equity | | | | $27,900 |

As a second step, a new loan amount may be calculated by using surplus equity as cash out, as shown:

| | |
|---|---|
| Total debt | $72,100 |
| Surplus Equity as cash out | $27,900 |
| New Preferred Loan Amount | $100,000 |

As an additional step, a new monthly payment might be calculated using existing customer debt as follows:

| | |
|---|---|
| Monthly payment on first mortgage | $900 |
| Monthly payment on second mortgage | $250 |
| (if any) | |
| Actual monthly payment for other debt | $300 |
| New Total monthly payment | $1,450 |

As type of option, the new loan amount, the submitted deal's rate, and the new total monthly payment, may be solved for the term. A deal is generated using these values, and the deal generated may then be displayed to customer 114, as follows:

| | |
|---|---|
| New Preferred Loan Amount | $100,000 |
| Submitted deal's rate | 0.17 |
| New Total Monthly Payment | $1,450 |
| Term (in years) | 24 |

As an additional loan option, a strategy for generation of a reduced term amount may include partially paying off customer 114s total debt balance to generate a new loan amount by, for example, a reduction in the total debt balance to 2/3 of the original and a maintaining of the cash-out, using the submitted deal's rate, and a maintaining of the new total monthly payment as calculated hereinabove. The term of the offered loan may then be derived. An example of these manipulations may be as follows:

| | | | | | |
|---|---|---|---|---|---|
| Balance on collateral | $50,000 | | | | |
| property's first | | | | | |
| mortgage | | | | | |
| Balance on collateral | $10,000 | | | | |
| property's second | | | | | |
| mortgage | | | | | |
| (if any) | | | | | |
| Total other debt | +$10,000 | | | | |
| balance | | | | | |
| Total balance | | $70,000 | | | |
| Closing costs | | +$2,000 | | | |
| Total debt | | | $72,000 | | |
| ⅔ total debt | | | | $48,000 | |
| Original cash out | | | | $27,900 | |
| New Loan Amount | | | | | $75,900 |
| New Loan Amount | | $75,900 | | | |
| Deal's rate | | 0.17 | | | |
| New Total Monthly Payment | | $1,450 | | | |
| Term (in years) | | 9 | | | |

Additionally, in a reduced term loan option, a fixed term, for example, a twenty year term, may be used, and a solution for the monthly payment may be calculated using the new loan amount and the submitted deal rate as stated hereinabove. For example:

| | |
|---|---|
| Total loan amount | $100000 |
| Rate | 0.17 |
| Payment | $1492 |
| Years | 20 |

In the three examples set forth hereinabove, results may be provided to the potential borrower, and successfully generated loan options, and/or benefits and/or explanations thereof, may be advantageously displayed.

The present invention may additionally include a pre-qualification, or pre-approval, request (hereinafter collectively “pre-qualification”). A pre-qualification request may provide a user of DSS, such as a potential borrower or broker, with the ability to qualify for one of the loan programs represented within ELA 306. This strategy assumes that the borrower does not yet know the value of the home the borrower wishes to purchase, but does know what amount of money is available to use for down payment and closing costs.

A request to DSS solves for the maximum loan amount available based on the borrower's credit, payment patterns, etc. For example, if the borrower's credit qualifies the borrower for a 90% LTV product, then the specified down payment (minus the closing costs) will be treated as 10% of the purchase price. This may be used to compute the maximum allowable purchase price.

The request for a pre-qualification loan amount may be generated using several inputs. For example, the potential borrower may be queried by DSS to input an available down payment. This is the total amount of money that the borrower has to put toward the purchase. This amount will be used for the loan down payment as well as the buyer-paid loan fees and closing costs.

The available down payment may be derived from numerous sources, and may be broken down into an amount of down payment from a gift, an amount from the proceeds of a sale of an asset (i.e. car, stock), an amount from sale proceeds of an existing home, an amount from money applied from rent (i.e. land sale, lease contract agreements), and an amount from a loan against a 401k retirement account, for example. In addition, DSS may also request additional information, such as term and monthly payment against a 401K borrowed amount. This information may be used to create a trade line for the loan wherein the 401k loan may be counted against the borrowers DTI.

In addition, the potential borrower may be asked to specify a number of loan origination points the borrower is willing to pay. Note that, if a broker is using DSS, this input parameter may also include borrower points paid to the broker and broker points paid by lender. In an embodiment, if the loan discount points (i.e. loan origination points) are omitted from the request, then ELA 306 may default to a standard point amount for the selected loan product. Term and amortization duration may also be asked of the borrower, as well as property type (i.e. residential or commercial), whether the borrower will occupy the property, and the income of the potential borrower. In order to properly estimate closing costs and fees, the loan state and county may also be needed from the borrower.

The request for a pre-qualification loan value may be calculated using the credit grading, as discussed hereinabove for other loan types, and using the above-entered information. In an embodiment wherein an arrangement is made with a major credit agency wherein a credit report check does not adversely affect the credit rating of the potential borrower, then the potential borrower's credit will not be adversely affected by multiple requests for pre-qualification loan amount information.

DSS may select applicable loan products, such as for the pre-qualification, using term, amortization, occupancy, property type, income validation type, or other entered parameters.

DSS may calculate each loan product, using loan attributes, which may include loan term and amortization, to compute a DTI. DSS may properly include or exclude mortgages on other properties owned by the borrower(s), based upon whether or not the properties are being sold in the proposed transaction. DSS may additionally compare the computed DTI to the selected loan products DTI requirement, in order to assess whether the product remains a proper fit for the financial background, and as such remains a viable option for the potential borrower.

Once at least one loan product has been found, DSS may compute the estimated closing costs based on relevant parameters input by the potential borrower (i.e. term, amortization, loan state and county). The DSS next subtracts the estimated closing costs from the borrower's available down payment and applies the remainder as the new down payment. DSS then computes the maximum loan amount that the potential borrower may pre-qualify for based on the LTV of the selected loan product. These results may then be displayed for consideration by the borrower.

Alternatives to the pre-qualification loan may be generated by varying the loan discount points or loan origination points up or down and re-calculating a pre-qualifying amount as stated hereinabove. Alternatively, the term and amortization parameters of the proposed loan may be varied. It will be apparent to those skilled in the art that pre-qualification may be employed by a potential borrower to assess whether the potential borrower pre-qualifies for a known loan amount, such as in an embodiment wherein the borrower has identified a specific property desired for purchase and knows the projected sales price. Thus, a request for a pre-qualification may allow for the entry by the potential borrower of a purchase price in addition to the available down payment including down payment amounts from all sources, the loan discount points desired, the term and amortization of the loan, the occupancy type, property type, income value and income validation type, and the state and county location of the property. A pre-qualification deal may be verified, as stated hereinabove. Further, alternatives, such as alternatives employing variations in discount points, or amortization, may be available with a pre-qualification deal, in a manner similar to the alternatives produced for other loan types hereinabove.

Upon selection of a loan by customer 114, DSS may transfer all relevant information to allow for a final processing of loan acquisition as described hereinbelow.

If an option for which customer 1 14 is eligible is identified in the process described hereinabove, the offeror must still determine the stipulations that apply to customer 114 for the generated loan option. Stipulations are conditions that customer 114 must meet before final approval of the deal. Examples of stipulations include the provision of documents such as a clear title, property appraisal, credit report, and flood certificate. Offerors specify stipulations for virtually all options offered to customers.

There are at least three basic types of stipulations: stipulations based on documentation type and income type; stipulations based on other attributes of customer 114 and the specific product; and stipulations based on other miscellaneous factors. Documentation and income stipulations are based on the Documentation Type (full documentation, no income qualification, no income validation, or 24 month bank statement program, for example) and other income-related information provide by customer 114. Examples of this type of stipulation include requiring customer 114 to submit copies of their W-2 statements covering the preceding two years if customer 114 is a salaried or hourly employee, or bank statements covering the preceding six months if customer 114 is self-employed, for example. Stipulations based on customer attributes include requiring customer 114 to provide a copy of documentation for the first secured loan on a property if customer 114 is requesting a loan that will be junior to the first secured loan, or proof of rental payments if customer 114 does not currently own a home, for example. Miscellaneous stipulations include requiring customer 114 to provide a copy of the divorce decree if customer 114 is recently divorced, or requiring customer 114 to provide the discharge notice if customer 114 has previously claimed bankruptcy, for example. Tables 22 to 24 list exemplary rules used to generate a stipulation list.

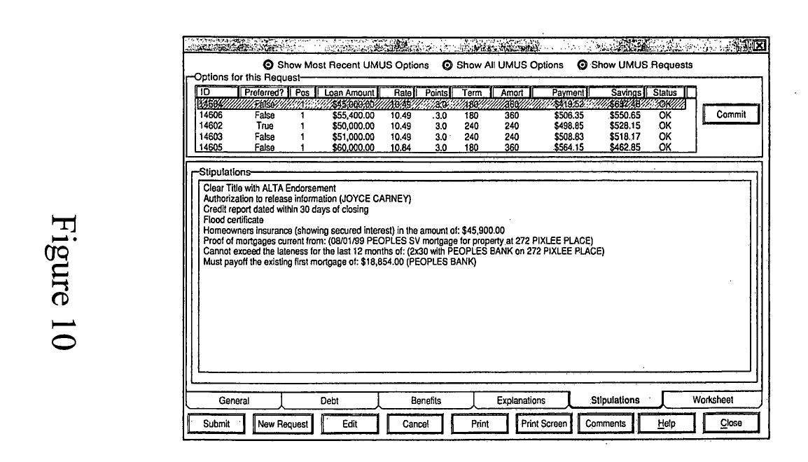

Once a product is identified for which customer 114 is eligible, the system generates a stipulations list for that product. The list is generated by applying the Stipulations rules to the information contained in the deal structuring record. The list of stipulations generated may be displayed on a user interface, as shown on FIG. 10. Once the user has identified 1102 the loan product for which he or she is interested in reviewing the stipulations, the user may, for example, select a “Stipulations” tab 1104, causing the stipulations to be displayed 1106 in a window below the product list.

At the conclusion of the above referenced process, customer 114 may enter, for example, an application process based on the product option selected by that customer. This application process may also be automated, as is known in the art, and, during this application process, all information received during the process discussed herein may be verified and/or incorporated by an UW to approve or decline a product offering. Thus, the process and system of the present invention allow a customer to move from an introduction to deal structuring to, for example, a closing, without human intervention.

The underwrite/verify functionality of DSS may be employed after the potential borrower has complied with the stated stipulations, and/or submitted the requested W2's, appraisal information, and/or other supporting documentation. The underwrite/verify functionality responds to the stipulated data submittal and checks whether the proposed deal selected by the potential borrower is still valid in light of the received information. For example, the potential borrower may overestimate, or underestimate, income, inconsistent with W2s, or the appraisal of the desired, or presently owned, property may be different than that expected. DSS accepts the verification information from the potential customer, as input by, for example, a loan officer or loan broker, and attempts to re-generate the same loan deal that the potential borrower selected. If DSS may again generate the previous deal structure, based on the received information, then the deal passes the underwrite/verify step, and a closing can be scheduled.

If DSS software cannot again generate the same loan deal in light of the information received, then that particular loan deal fails. In that instance, one or more of the loan officer, broker, and potential borrower may be notified by e-mail, for example, that the selected loan has failed, but that other loan options are still possible. Also, under a failed condition, DSS may generate other optional deals that satisfy the new verified data constraints (i.e. W2's, appraisals, etc.). For example, if the original deal has a number of bills for consolidation, an option may be generated that pays off fewer total debts, but still structures a viable loan deal for the potential borrower. Additionally, for example, the loan amount, interest rate, loan origination points, or term of the failed loan may be altered by DSS in order to generate viable alternatives for the potential borrower.

The above referenced process may employ a commercial loan origination software package, such as one that incorporates a database management system configured specifically for the loan origination contemplated. Examples of commercial mortgage loan origination software packages include MortgageWare (INTERLINQ Software Corporation) and Virtual Mortgage Officer (Contour Software, Inc.), for example.

In certain embodiments of the present invention, a database or databases are used to store all information submitted by a customer, including customer 114's name, address, social security number, and preferred parameters, for example. The rules discussed hereinabove are, also, included in a database, which database is the same or related to the database including customer 114 information. The rules database includes the rules for multiple offerors, including the offeror and third party offerors, and the rules may be applied in a one-to-one fashion with customer 114, in a many-to-one fashion with customer 114, or in a one to many fashion with customer 114. As such, the options generated may be options from numerous offerors to one customer, from the primary offeror to customer 114, or from many customers to one offeror. Additionally, the parameters of each deal that is offered to customer 114 may be stored as well so that, for example, CSR's may later access such data. Stipulations, statements of benefits, explanations of underwriting decisions and other data relating to proposed loans may also be stored. In addition, rules relating to loan underwriting may also be stored in the same or a different database.

It should be noted that the present invention may be implemented without the use of a database, particularly in embodiments in which the amount of data to be stored and accessed is relatively small. For example, underwriting rules may be “hard coded” into executable code and data relating to potential borrowers and proposed loans may be stored in flat files.

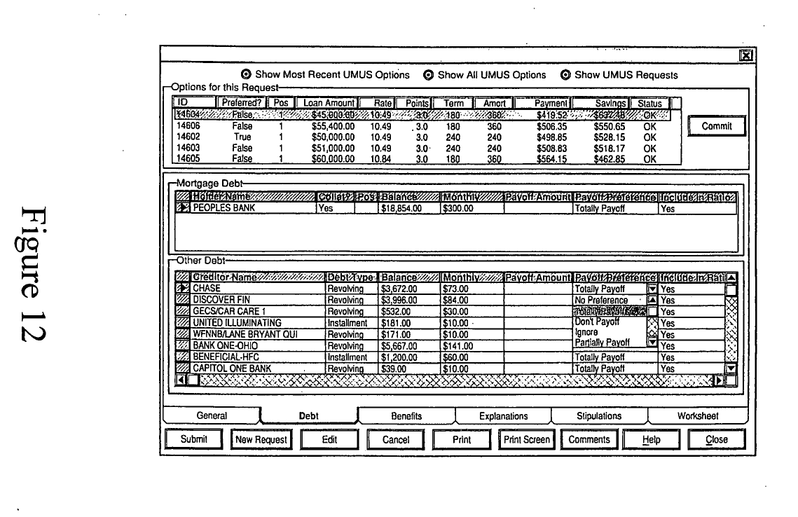

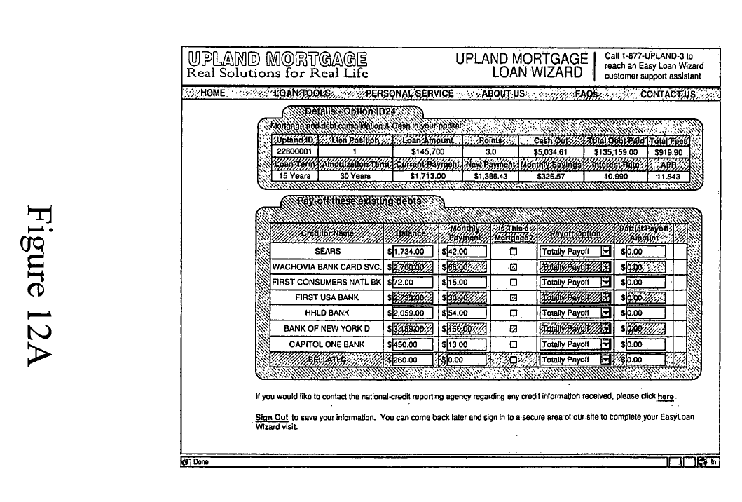

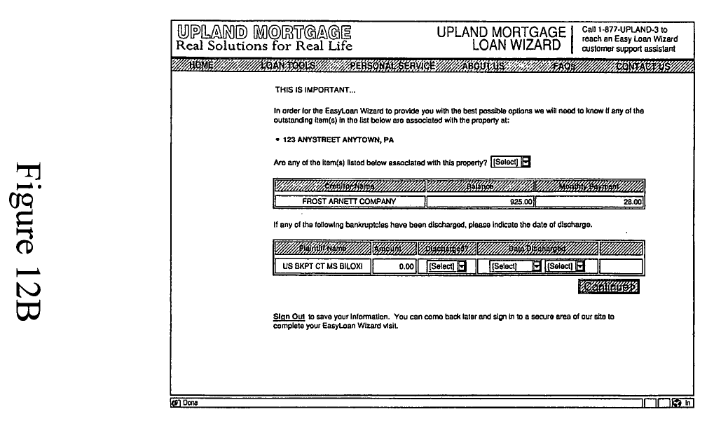

The following is a discussion of an embodiment of the flow of the method of the present invention. As shown in FIG. 12, a plurality of customer information is requested and received by MSS 108, possibly following the use of advisor 306. In the example shown, the loan amount requested by customer 114 is $45,900.00. The mortgage to be paid off on the collateral against which the present loan is to be taken is $18,854.00. Using this information, the debt information, the credit information for that customer, and the rules to be applied to the loan requested (for example, the exclusionary rules), MSS 108 attempts to generate a series of loan options for that customer. The loan options generated by MSS 108 may include details for each loan, such as whether the loan is a preferred loan from that particular lender, the loan amount the lender will extend to customer 114, the interest rate on each loan option, the points to be paid by customer 114 for each loan option, the term of the loan, the amortization of the loan, the monthly payments for the loan, and the savings and status of the loan, for example. Additional information may be included with each loan option. In some instances, the rules applied by the lender may prevent extension of loan options to customer 114. In such an instance, repair rules may be applied to the information supplied by customer 114, in an attempt to vary customer 114's request and to allow for extension of loan options to customer 114, or compensating factors may be applied to the rules themselves, in an attempt to vary the terms of the loan to compensate for customer 114's financial shortcomings.

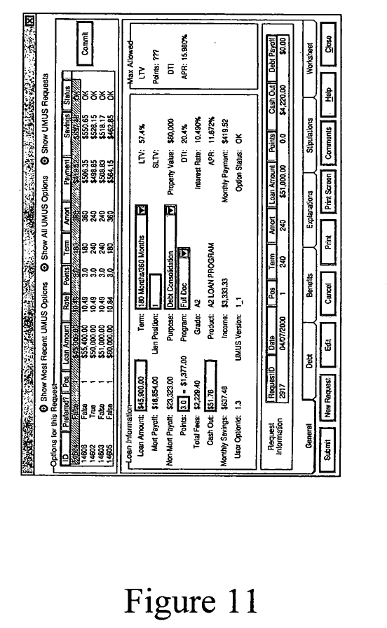

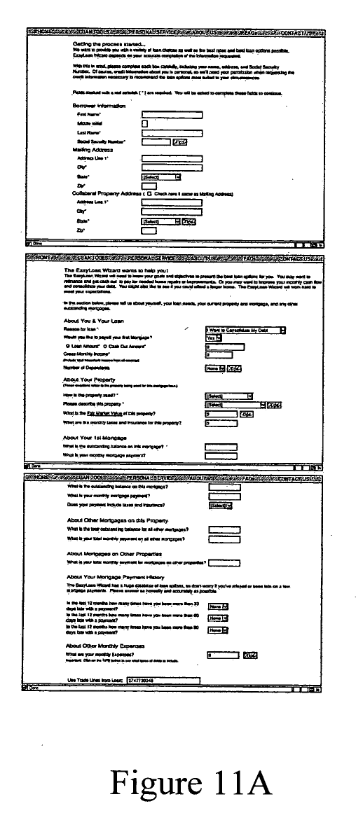

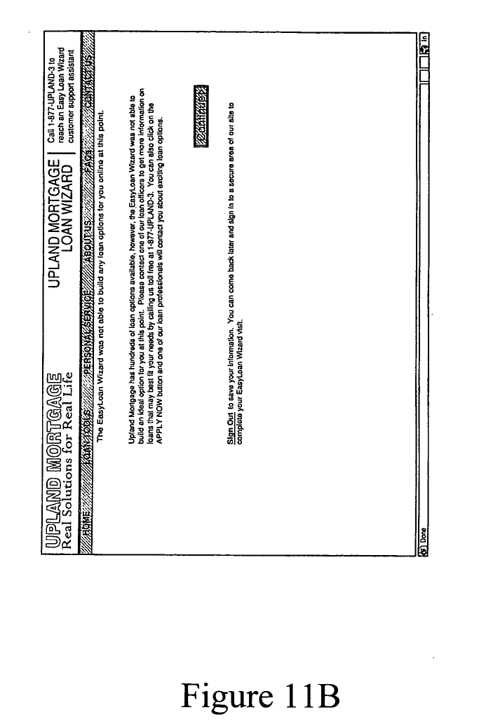

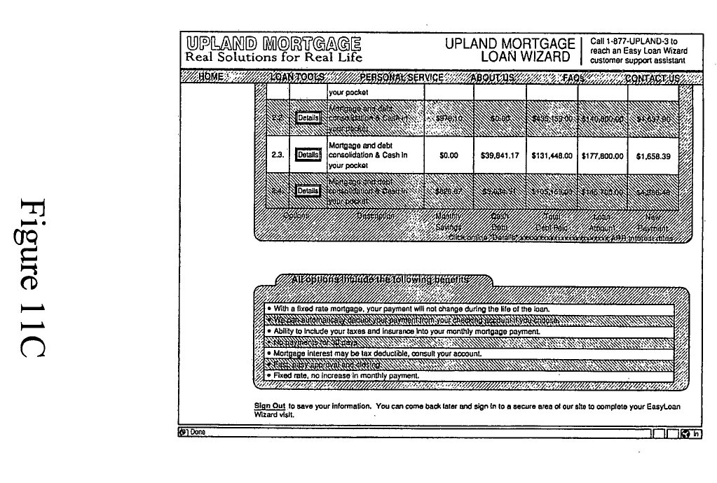

FIG. 11 may be generated, for example, for review by a loan officer. FIG. 11A shows an additional embodiment in which a customer may enter and receive similar information to that of FIG. 11, without direct contact with the loan officer. In the internet embodiment, customer 114 enters the information, as entered in FIG. 11, into a series of click and fill fields, as shown, after entry of the desired loan amount and criteria. Following entry of the information and loan amount by customer 114, and following entry of the debt and credit information for customer 114, a series of loan options maybe generated for customer 114, as shown in FIG. 11C.

In an embodiment, the internet embodiment may operate in conjunction with direct access to a CSR. In this embodiment, customer 114, while accessing MSS 108 over the internet, can, if certain predetermined conditions are met, directly contact a CSR. The CSR, upon being contacted by customer 114, may then access MSS 108, and gain real time access to the information and status then-entered by customer 114. Thereby, the loan officer may simultaneously review the same information displayed before customer 114, at the same time that information is being reviewed by customer 114, and therefore may better advise customer 114 and answer the questions of customer 114. Customer 114 through an internet chat window, email, or telephonic connection may gain this direct access, for example. In an embodiment, wherein customer 114 is speaking with a CSR, which CSR is entering information as in FIG. 12, customer 114 can, via an internet connection or the like, gain real time access to that then-currently being shown to the CSR.

According to FIG. 11C, each loan is shown with information similar to that shown in FIG. 11, and additionally may be shown with a click option, which click option, if clicked by customer 114, shows additional details of any selective loan. In an embodiment wherein similar benefits are available for each loan type, the common benefits to each loan type may additionally be displayed with the loan options, as shown in FIG. 11C. If, following entry of all loan requests, criteria, and debt information, no loan is available, customer 114 may be presented with a screen such as that shown in FIG. 11C.

FIG. 12 shows the entry of debt information corresponding to each customer. In the embodiment of FIG. 12, the loan options may be displayed in conjunction with the debt information. The debt entry fields of FIG. 12 may be filled by customer 114 or a loan officer, and should include creditor name, the type of debt, the balance due the creditor, the amount of monthly payments, the payoff amount, the payoff preference, and the inclusion in the debt ratio. The payoff preference may be used by customer 114 to payoff debts not owed to the lender in part or in full, using the amount borrowed from the lender in the loan for which the present deal structuring is made. FIGS. 12A and 12B show additional embodiments of the debt entry fields. Information similar to that entered in FIG. 12 is entered into the screens by click and fill fields in FIGS. 12A and 12B. Customer 114 is again presented with the option to pay off debt using the amount borrowed in the present deal structuring in the embodiments of FIGS. 1 1A and 11 B.

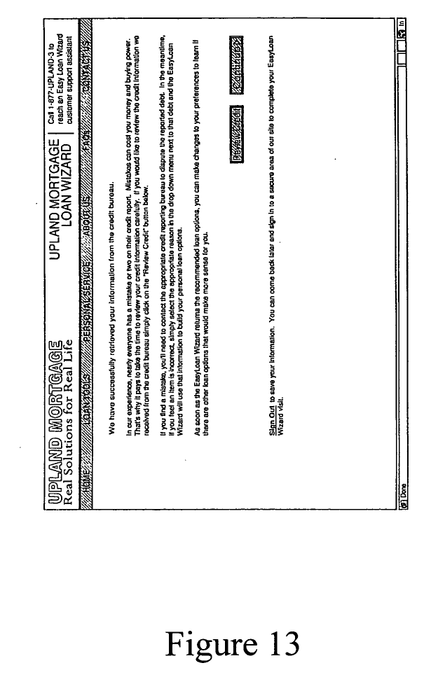

In the deal structuring of each of FIGS. 11, 12, 12A, 12B, the credit information for customer 114 must be accessed by the lender in order to generate loan options. This access may either be done by a loan officer, after gaining authorization from customer 114, or, in an internet deal structuring, may be performed by the automated system after customer 114 clicks an authorization button. A click-able credit review authorization is shown in FIG. 13.

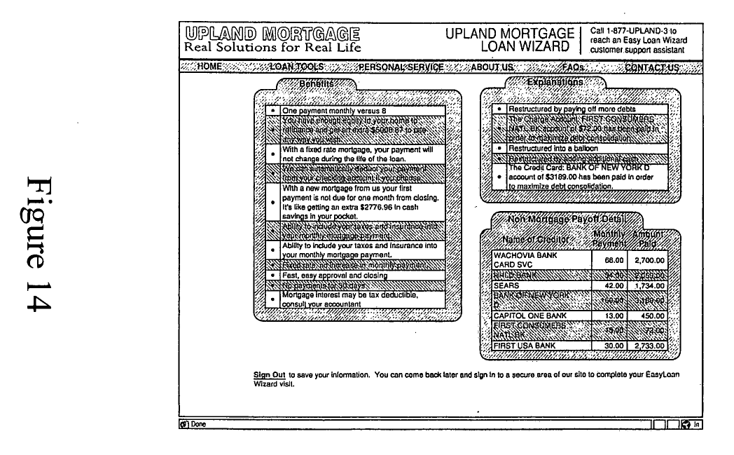

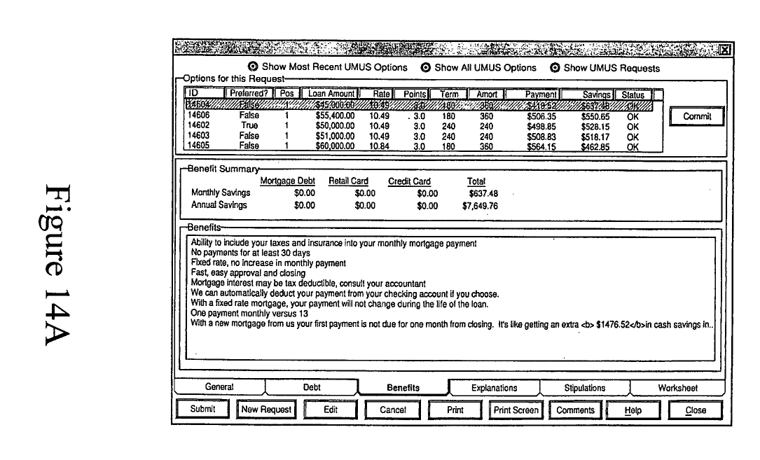

Following the review of the debt information and credit history from customer 114, the loan options may be generated. Upon generation of the loan options, customer 114 may be presented with the benefits available through a choice of any one or all of the loan options. The benefit may be, for example, a reduction in total monthly payment, or a reduction in the number of creditors to which customer 114 must make payment. Several of the benefits may be unique to each customer. For example, customer 114 receives a unique individualized assessment of the monthly payment amount and savings, or the number of monthly payments to be made. In an internet embodiment, the benefits may be displayed in tabbed format, as shown in FIG. 14. It will be understood by those skilled in the art that numerous other benefits may be available, in addition to those displayed in FIG. 14. In an embodiment wherein customer 114 is speaking with a loan officer, and in which the loan officer is accessing MSS 108, the benefits may be displayed by clicking on a benefits tab as shown in FIG. 14A.

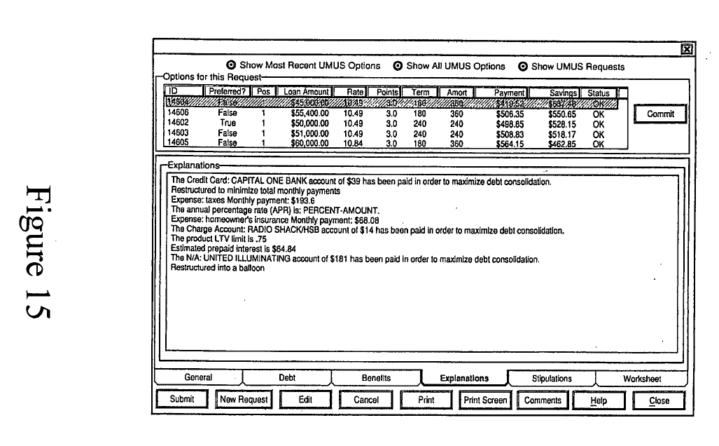

In addition to stating the benefits available for each loan option, MSS 108 may be used to present explanations to customer 114s of any repairs, compensations, or changes necessary to enable the lender to present customer 114 with a loan option. In addition, these explanations may include reasons why a loan, or a preferred deal, was available, or not available, to a particular customer. The explanations may additionally include general explanations as to loan types, amounts, and payments. In the embodiment wherein a loan officer is discussing the loan with customer 114 via telephone, for example, the explanations may be displayed to the loan officer by clicking on a tab marked explanations, as shown in FIG. 15. In the internet embodiment, the explanations may be presented in tabbed form to customer 114 as shown in FIG. 14. It should be noted that the explanations may be presented in conjunction with the benefits, or separately from the benefits, and that the explanations are preferably audience specific. In the exemplary embodiment of FIG. 14, it was required that customer 114's loan be restructured in order to make the loan available to customer 114. In the example shown, the loan needed to be restructured, more debts paid off, and the loan made into a balloon type, in order to make the loan available to customer 114, and thus these items are included in the explanation.

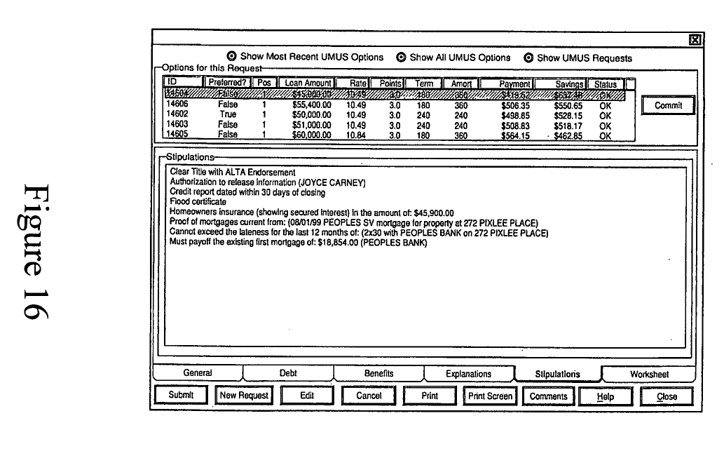

As shown in FIG. 16, each loan may include stipulations that must be met by customer 114 in order to make the loan available to customer 114. These stipulations are generally known to those in the art, and may include, for example, clearing title to the mortgaged property, authorization by customer 114 to release certain loan related information, a credit report dated within thirty days of closing, and various types of insurance. Several of these stipulations are shown in FIG. 16. Similarly, the stipulations may be made available to customer 114 in an internet embodiment, using, for example, the tabbed format similar to that of the benefits and explanations.

Should customer 114 not wish to accept any of the loan options made available to customer 114, customer 114 may have available, through MSS 108, an option to make a counteroffer to the lender, by editing customer 114's own initial preferences. The lender may then apply the rules, repair, and/or compensating factors to the counteroffer, and choose to make or not make the counteroffer a loan option. This editing preference process may continue for a predetermined number of iterations, or may be continued indefinitely.

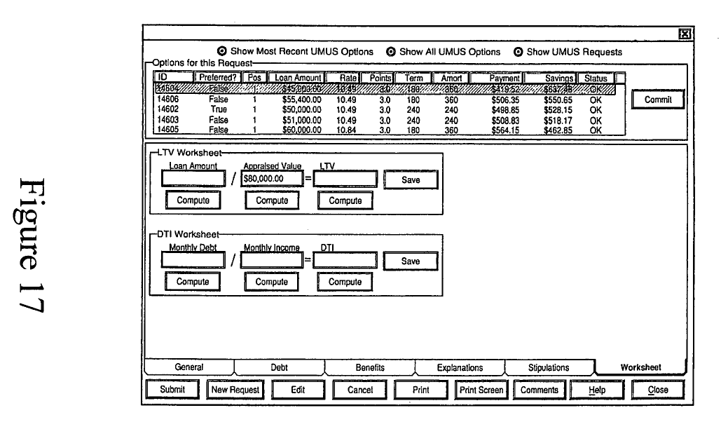

At predetermined points during the deal structuring process, customer 114 may have made available a work sheet that allows for the computation of LTV and DTI values, for example. The work sheet is made available to allow customer 114 to determine, prior to deal structuring, the loans for which customer 114 may be made eligible. The work sheet generally includes click and fill numerical fields in an equation format. An example of a work sheet is shown as FIG. 17.

In an embodiment of the internet deal structuring, customer 114 has made available at all points during the deal structuring process an option to stop the deal structuring process, save at the current point in the deal structuring process, and resume the deal structuring process at a later point. This option is made available through either a menu selection option or a stop and save clickable icon button, for example. The stop and save option is a clickable option, and may include security measures known to those skilled in the art. Similarly, customer 114 may be guided through the entire process of an internet deal structuring using clickable icon “Continue” buttons, for example.

As discussed hereinabove, a user or customer of ELA may include a broker. Certain features of ELA may vary in accordance with user type, also as discussed hereinabove. Thus, a specific exemplary embodiment of the present invention enables a broker to send loans, give preliminary loan approval, and track the loans using an ELA based system, such as via a web site interface, for example. The broker interface may provide information related to services offered, allow online registrations by brokers, and may permit uploading or transferring applications between different system types using a standard electronic data interface format system, such as Morenet, for example. In such a configuration, a broker may register and obtain an ID and password, learn more about the system of the present invention, and login and use the system of the present invention, for example.

As shown in FIG. 18, a broker may login to the system using an existing valid user ID and password, obtained, for example, through online registration or other direct contact with the system administrator, wherein the login may be engaged by clicking on the log in button.

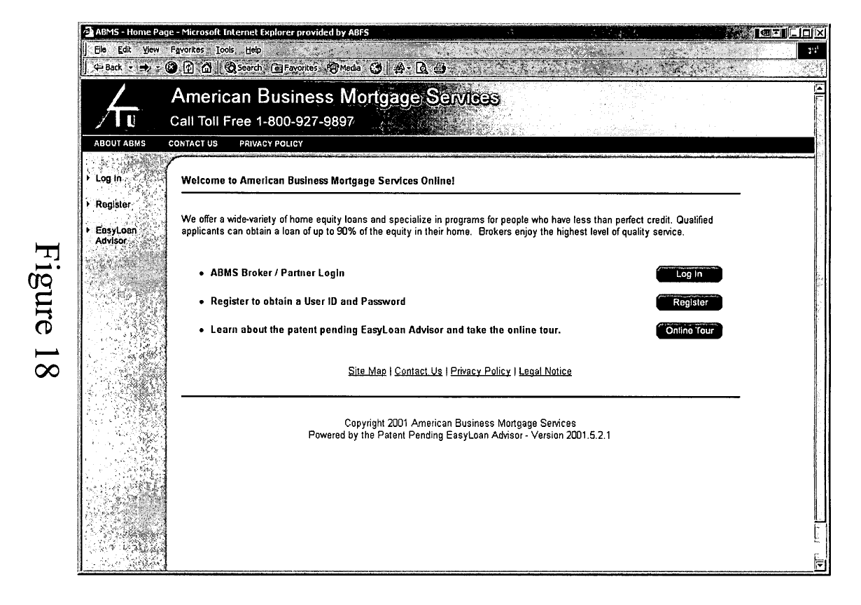

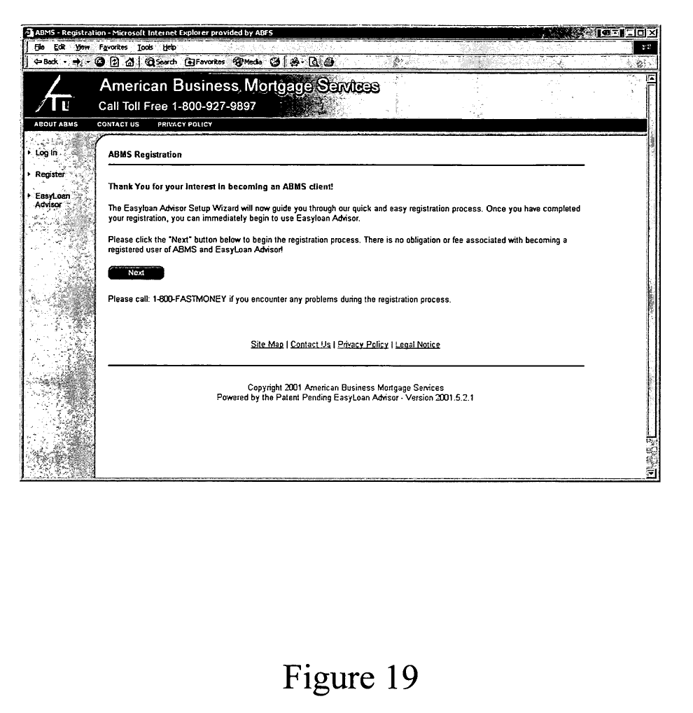

Registration with the system may occur by methods known to those possessing an ordinary skill in the pertinent arts, such as by phone, mail, or online. A broker may proceed with online registration by clicking the register button as shown in FIG. 18. The online registration process may be suitable for brokers that have not yet accessed the system, or employees of brokers seeking to establish an individual user ID and password. In order to increase the speed of broker entry, the present invention may permit online registration followed by immediate access to the present system, as is shown in FIG. 19. The registration process, whether online or otherwise, may not cost the applicant any fees or cause them to incur any obligation, or may be granted for a fee.

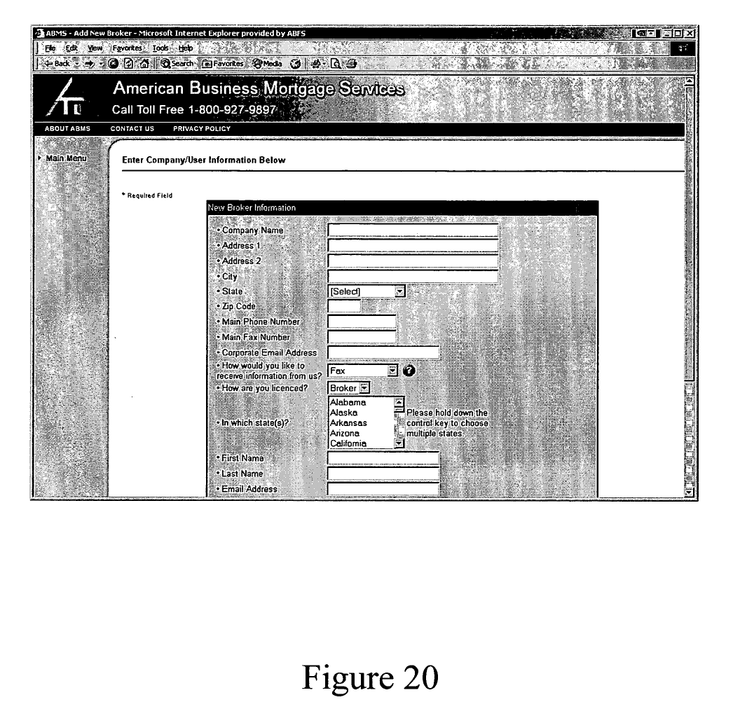

When registering, the entry of information occurs, such as officers, brokers, loan agents, and other pertinent information, including contact information, and this information may be entered into a profile. As shown in FIG. 20, this profile may include information such as company name, sub companies for companies that work through a particular broker, contact information, and license type, for example. The user may also choose a user ID and password, which may be validated during the registration process so as to not be duplicative. The user ID and password may be required by the system to have certain characteristics, such as for security purposes, for example. In addition, the entry of one or more brokers from a given company may occur. This may allow each broker to have different access authority, such that information available to all. Further, new users may be added as employees enter a brokerage. Similarly, users may be removed or have access authority reduced, such as if the user leaves the brokerage, for example. The profile may be edited as time passes and as information requires updating. The profile may permit a variety of tracking to occur. Such tracking may allow activity to be displayed and monitored based on broker data, account data, or corporate data, for example.

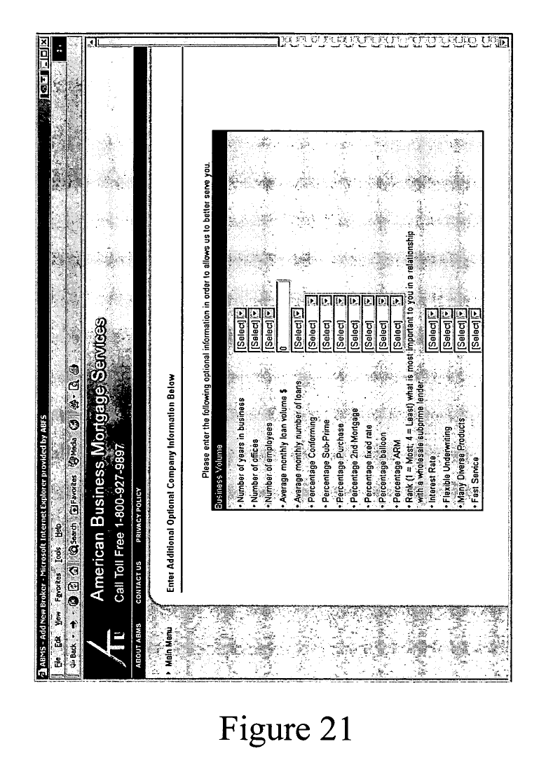

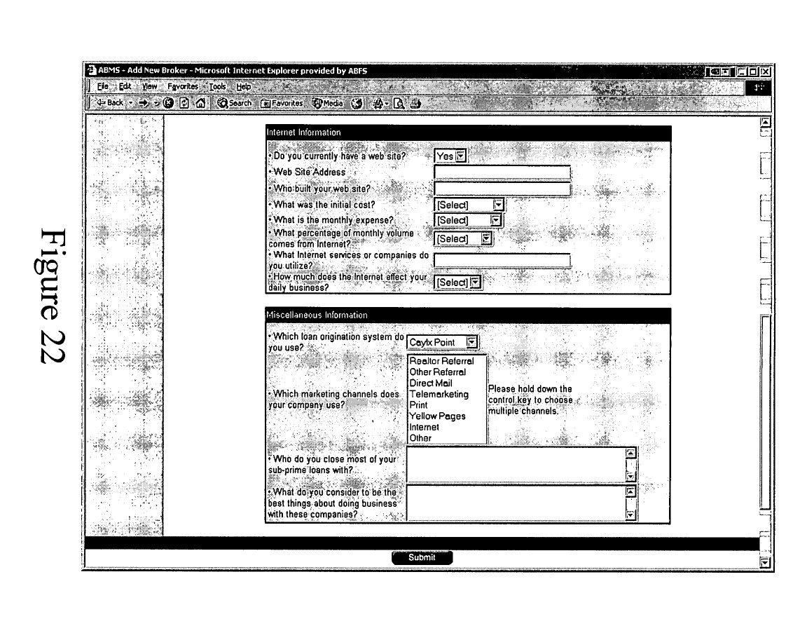

Information may also be collected during the registration process that may be used to tailor system functionality to better serve the broker, for example, as shown in FIG. 21. Such information may include, but is not limited to, number of offices, number of years in business, number of employees, average monthly loan volume dollar amount, average monthly loan origination's, percentage of conforming loans, sub-prime loans, purchase loans, second mortgage loans, fixed rate loans, balloon loans, ARM's, and the importance of obtaining a desired interest rate, flexible underwriting, diverse products, or expedient service, for example. FIG. 22 shows further information that may be collected by the system, including, but not limited to, web site information of the broker, loan origination software used, marketing channels used, e.g., referral, direct mail, yellow pages, etc., and various other questions relating to prior loan originations and customer satisfaction, for example.

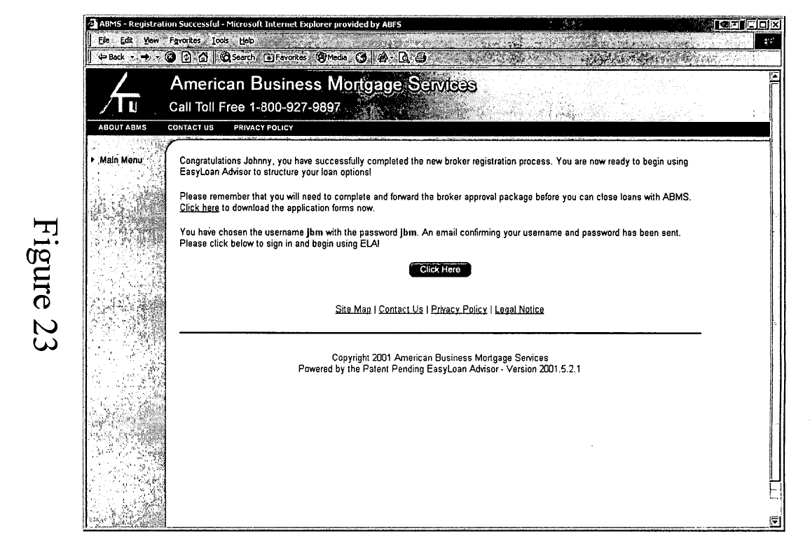

The completion of the online registration process is shown in FIG. 23. By clicking the appropriate button, the applicant may be provided instant access to the present system. The system may also require additional forms to be completed in order to close loans, e.g., a broker approval package, that may be completed online, via email, download, or direct contact with the system administrator.

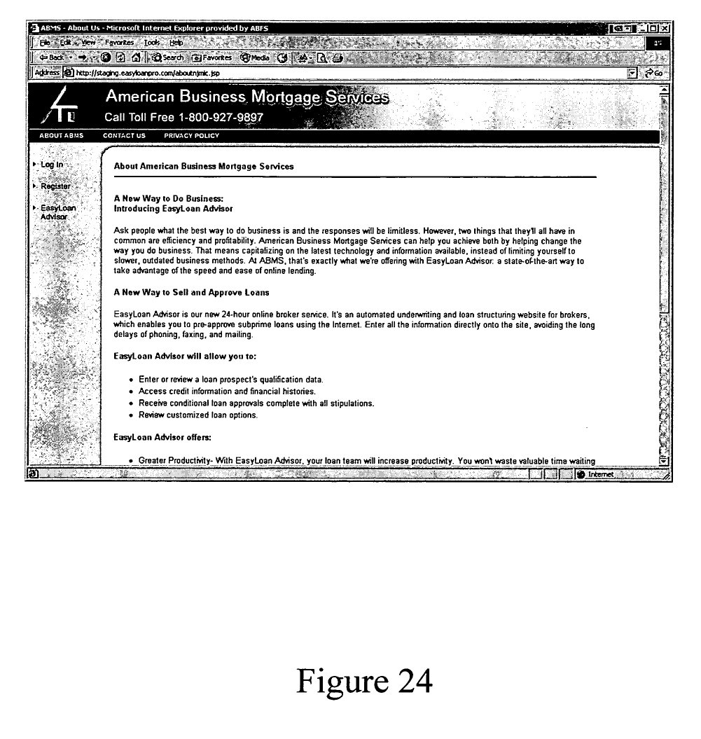

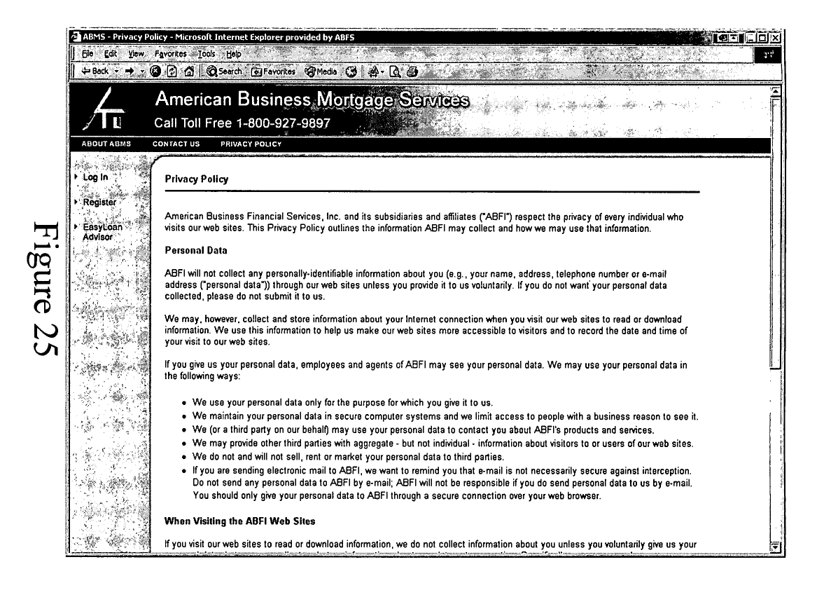

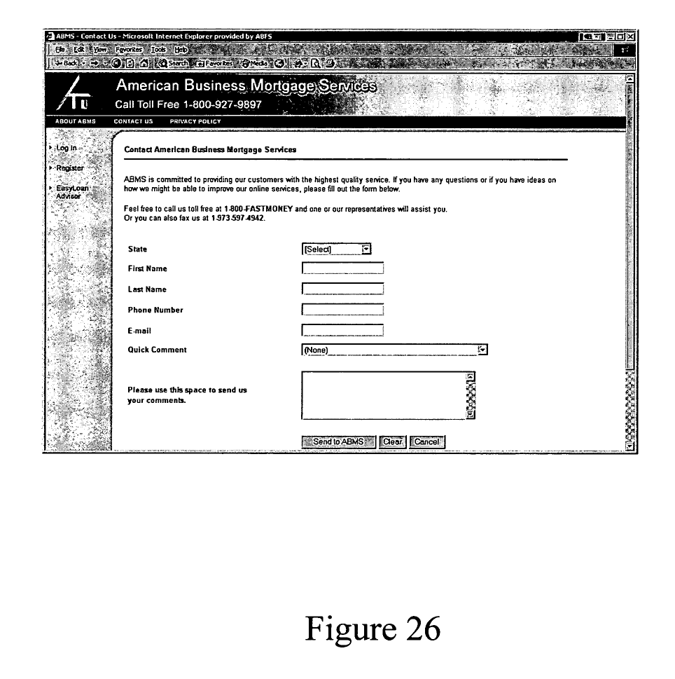

Further, FIG. 18 shows tabs that link via clicking highlighted links to pages that provide a site map for directing a user through the system, access to contact information and accessibility thereof, and miscellaneous information related to the website and the system, for example. FIG. 24, for example, illustrates a linked through web page containing information that includes, but is not limited to, information regarding the system administrator, availability and functionality of the system, and benefits of using the system. Additionally, FIG. 25 shows miscellaneous information related to the website and the system, that may include, for example, a privacy policy. Further still, FIG. 26 shows contact information of, for example, the system administrator, and may provide access to the system administrator via email, telephone, direct mail, instant messaging, and live conferencing, for example.

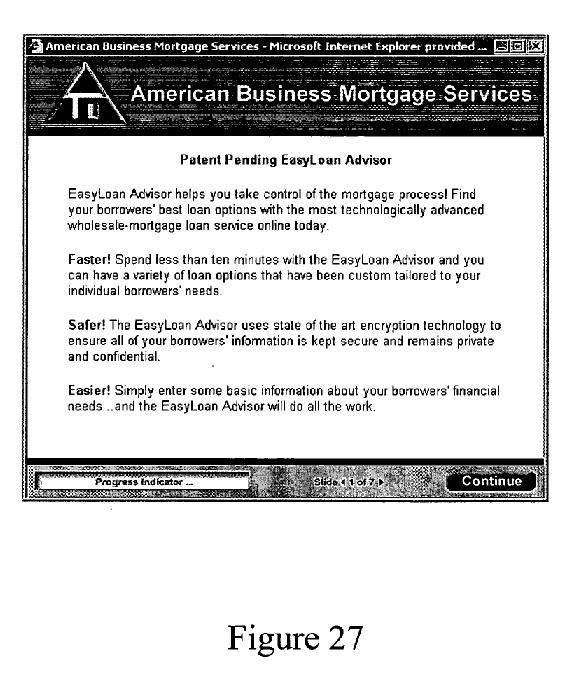

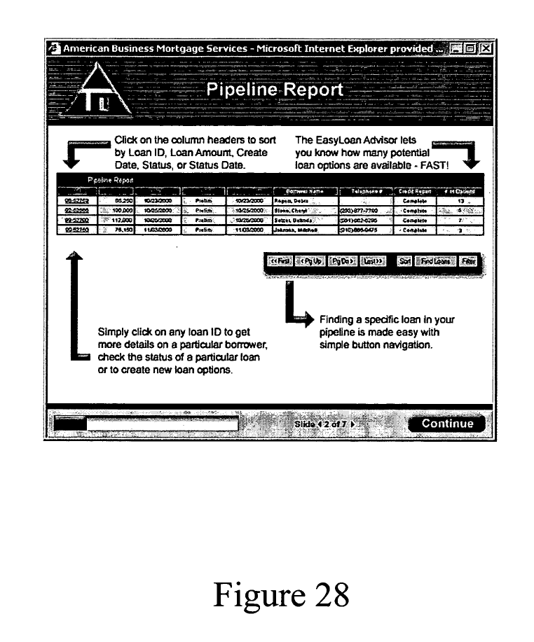

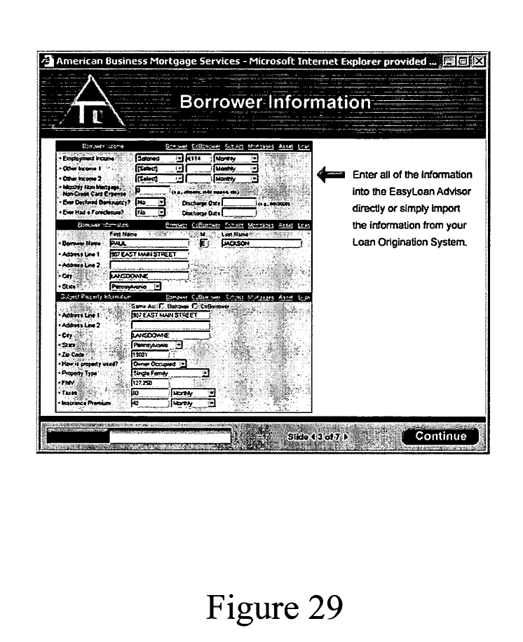

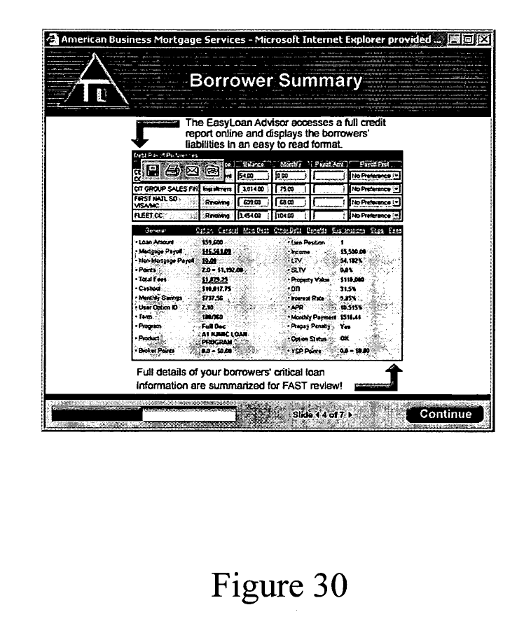

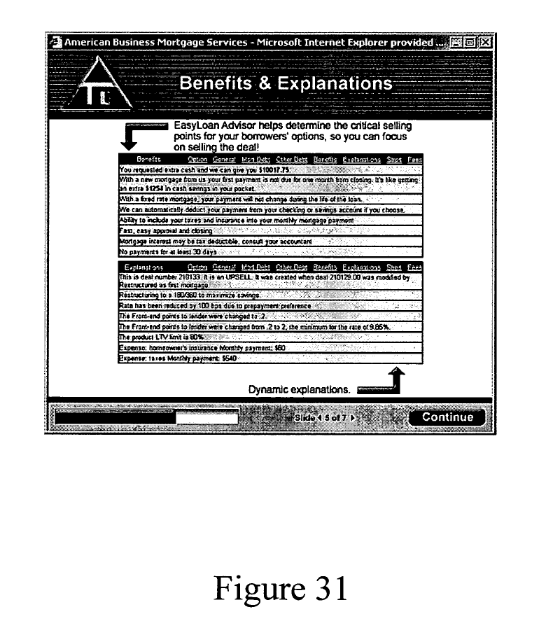

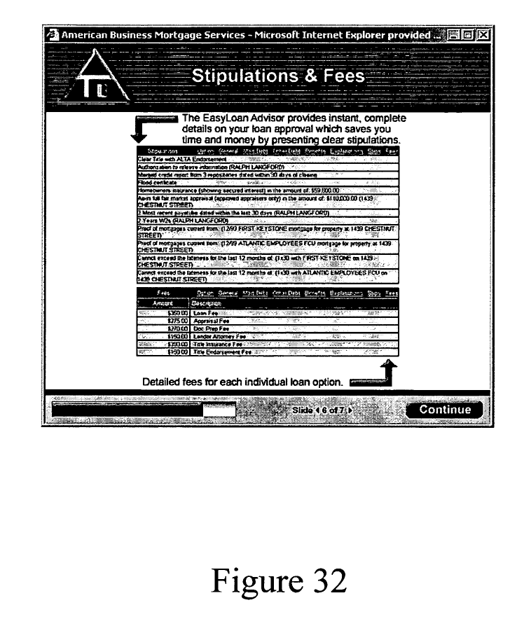

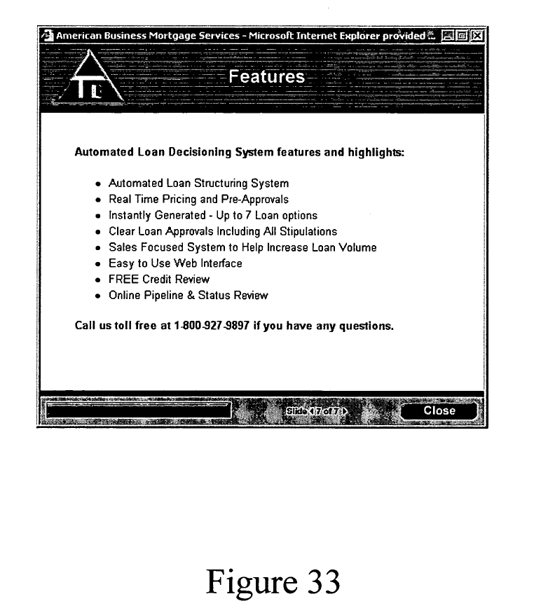

As mentioned above, the system may provide an online tour which may allow a broker to learn more about the system of the present invention. The online tour may outline the overall system (as shown in FIG. 27), provide a description of a pipeline report (as shown in FIG. 28), describe borrower information fields (as shown in FIG. 29), borrower summaries (as shown in FIG. 30), benefits and explanations (as shown in FIG. 31), stipulations and fees (as shown in FIG. 32), and features (as shown in FIG. 33), for example. This tour may be viewed in an order desired by the applicant, ordered in advance by predetermined variables, or ordered but advanced at applicant's own pace, for example.

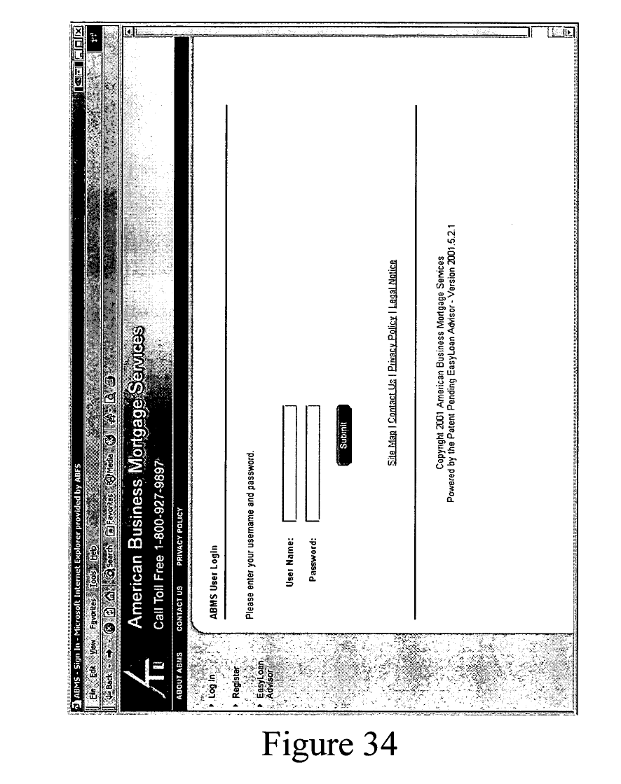

If the “Login” icon is clicked in FIG. 18, the user may be forwarded to a login screen as shown in FIG. 34. The login screen may have two primary fields, one for a user ID and one for a password. When the appropriate fields are populated, the information contained therein may be processed by clicking on the “Submit” icon. The user ID and password as entered may be checked against a database to ensure the validity of the combination. If such validity is not warranted, the system may present the login screen again with fields blank. The system may also, after one or more failed attempts of establishing a valid combination, deny the user access to the website during a session.

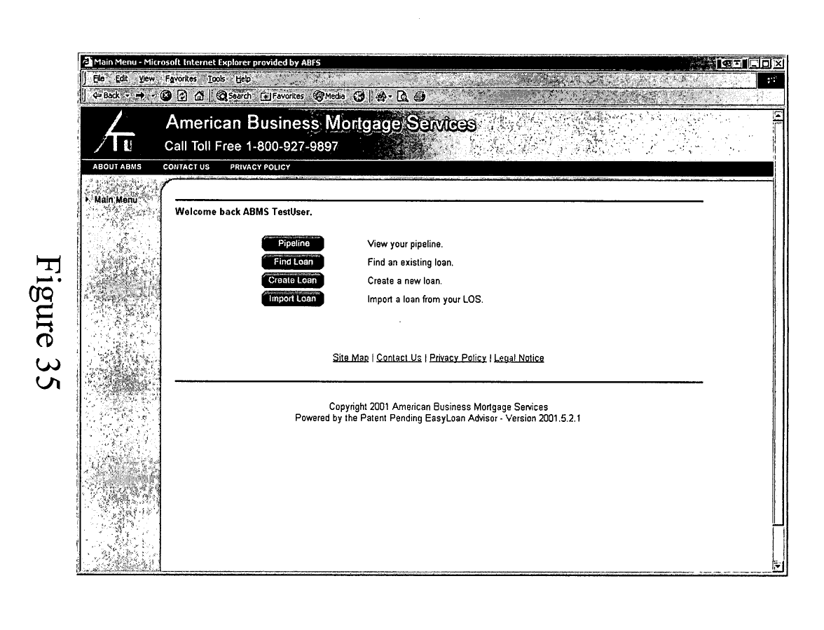

A successful login may forward a broker to a main menu as illustrated in FIG. 35. This main menu may allow a broker to view the current loan pipeline, find an existing loan, create a new loan, import a loan from loan origination software (LOS), and view and edit profile, for example.

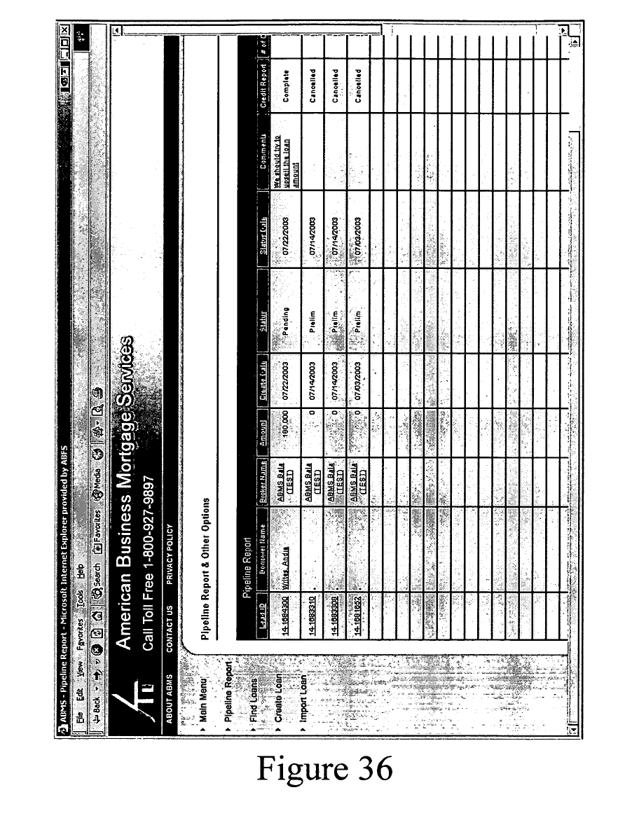

By clicking on the “Pipeline” icon as show in FIG. 35, the broker is forwarded to a pipeline, as illustrated in FIG. 36, for example. For the sake of the current discussions, pipelines are herein defined as the set of applications in progress. A pipeline may show at least one loan application that may be entered through the website by a broker. The at least one loan application may be sorted by loan number, or may be sorted by clicking on any column heading, including, but not limited to, dollar value, status, and object property address, for example. This pipeline report may also allow a broker to obtain more specific details about information presented in the pipeline by clicking, for example, on the loan number associated with the loan of interest and thereby hyperlinking to that loan. Further, a pipeline report may be large enough to warrant the use of a separate navigation bar that would allow the broker to move among the loan options listed by forwarding to the beginning of the list, the end, paging up and down, filtering, sorting and searching the report, for example.

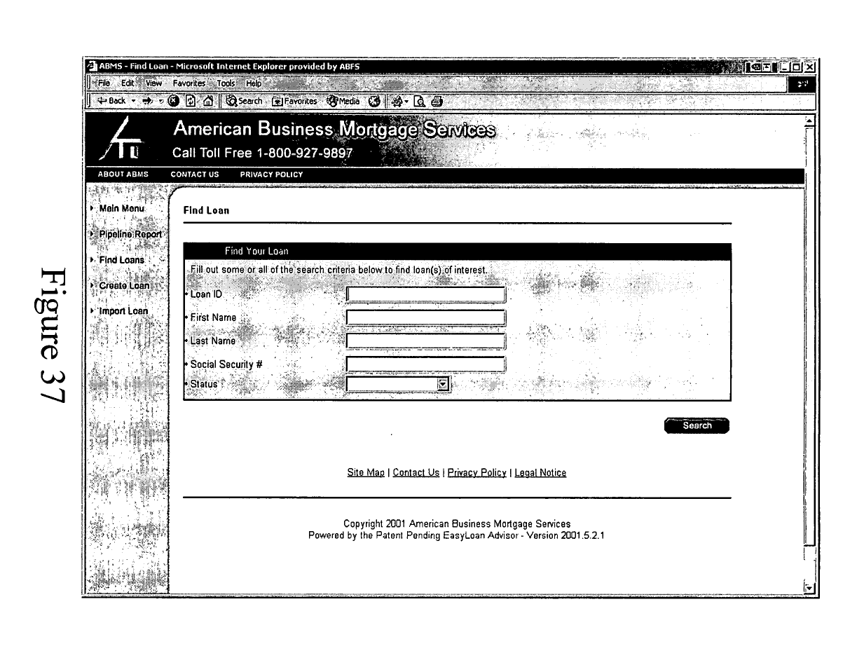

A broker may also find loans in the system of the present invention by clicking the “Find Loan” icon from a main menu as shown in FIG. 35. The system may then provide the broker with a search screen that may allow the broker to search for one or more loans using one or more search criteria, as illustrated in FIG. 37. Such search criteria may include, but are not limited to, one or more of loan ID number, the borrower's first name, last name, social security number, and the status of the loan, for example. Once a field corresponding to a search criteria is populated, a search for a loan may be initiated by clicking on the “Search” icon. The system may then provide a list of one or more loans and may provide similar information as is displayed in a pipeline as discussed above. The broker may then click on any one or more of the loans resulting from the search for more information regarding the loan to edit or modify the loan as appropriate and allowed by the system.

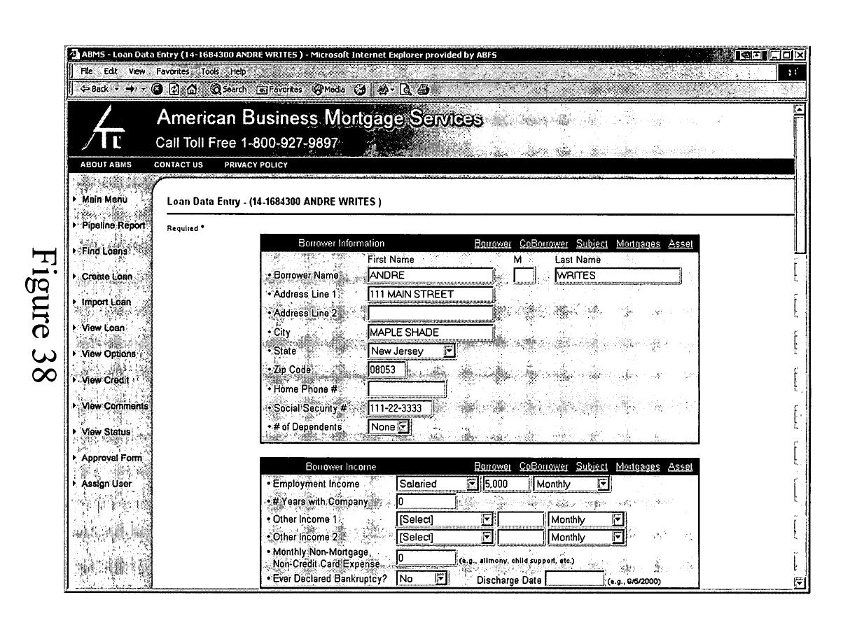

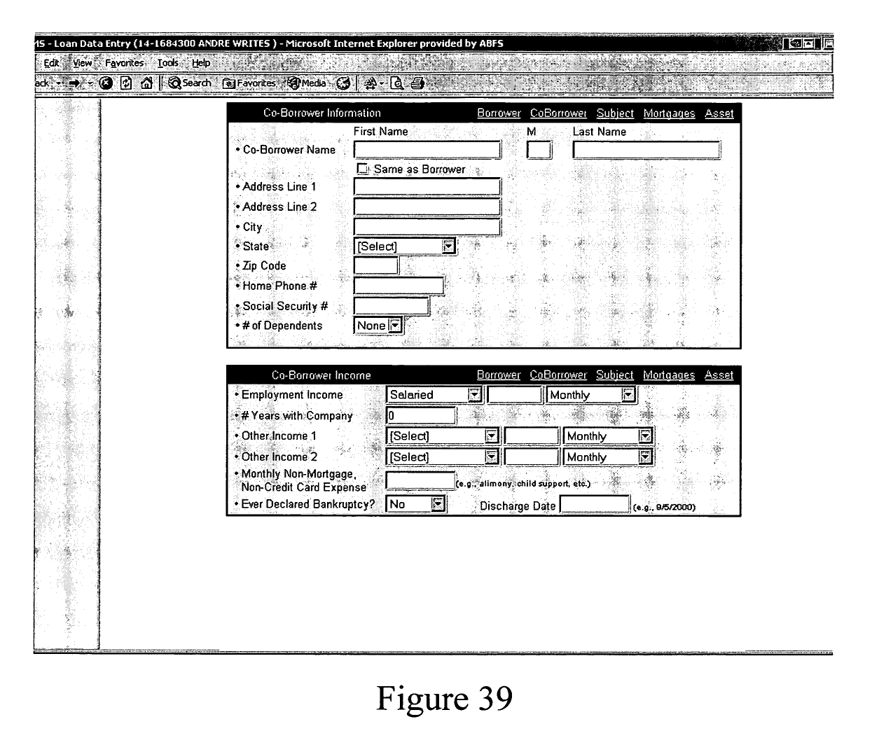

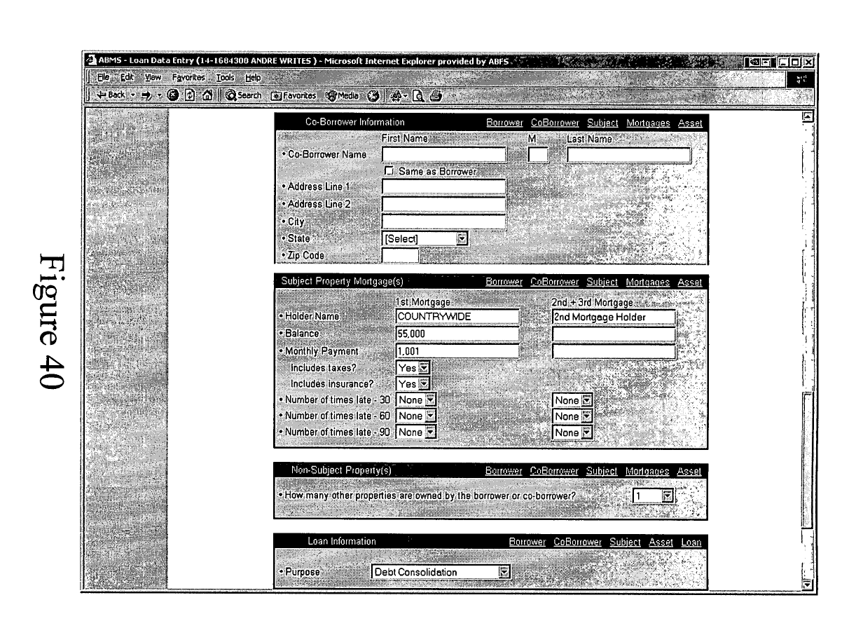

Further, a broker can create a new loan by clicking the “Create Loan” icon as shown in FIG. 35. As illustrated in FIGS. 38-40, the broker may enter borrower information into the system for the purpose of creating a new loan which may include, by way of non-limiting example only, a purchase mortgage or refinance. Fields for data entry may include, but are not limited to, the borrower's name, contact information, social security number, income information, pertinent co-borrower information, subject property information, non-subject property information, and other loan information, for example. Information entered in the new loan process may be confirmed and edited at any point accessible by the broker in the system.

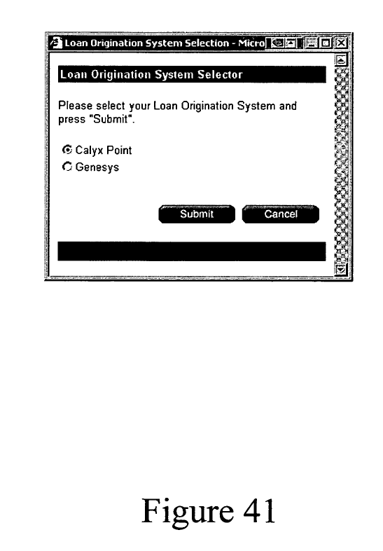

If the broker has a loan to import, the broker may enter information accordingly, such as by clicking on an “Import Loan” icon for example, as illustrated in FIG. 35. The system may respond to such a click and may prompt the broker to select an importing format in which to bring the data into the present system as is shown in FIG. 41. By way of non-limiting example, a loan may be imported for Smith (client name) from a Calyx Point system into the current system, via website. By providing such an import device, the present invention is configured to alleviate the necessity of re-keying information. This may save brokers time and resources and allow for a greater flow of loan information into the present system. Brokers may operate in a myriad of software, and the present invention may thus alleviate a bottleneck in integrating various brokers and brokerage firms.

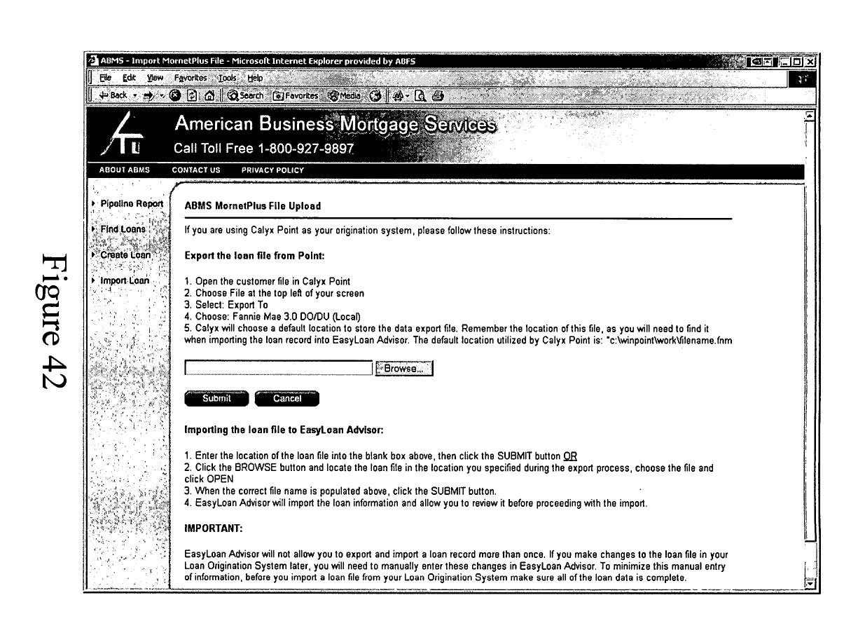

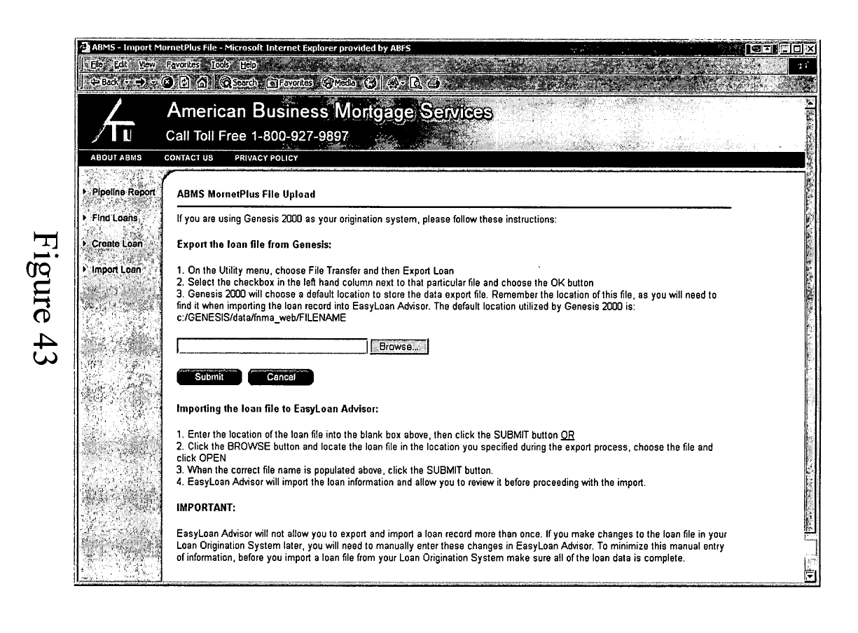

As shown in FIGS. 42 and 43, the system provides step by step instructions for importing loan information from an existing broker system. The system may provide the option to browse the broker's system for the at least one import file, and may import the file when the broker clicks the “Submit” icon. The broker may also have the option to cancel the transaction and return to a main menu by clicking the “Cancel” icon. After clicking the “submit” icon, the system may ask the broker to confirm that the at least one import file is correct, and may then proceed with importation.

When importing information, pop up screens or alerts may be designated to request more information, if such information is absent in the prior version of the loan information. Further, missing loan information may be autofilled, during which the broker may be alerted and presented with the AutoFill value. The broker may also elect, upon being asked by the system, to allow additional borrower information to be imported into the system, such as, by way of non-limiting example, the borrower's credit history. The system may also consolidate and enhance imported information. By way of non-limiting example only, imported credit history of the borrower and at least one co-borrower, Stan and Mike, for example, can be merged together to filter out inconsistencies among multiple credit bureaus, ignore unwanted credit information such as loans which have been “Paid Off”, and can more clearly show properties and/or liabilities that may otherwise not be noticed.

As with all the preceding options of finding a loan, creating a loan, and importing a loan, a broker may have the ability to view a loan, change view options, view credit, comments, status, access approval forms, and assign and edit at least one additional user.

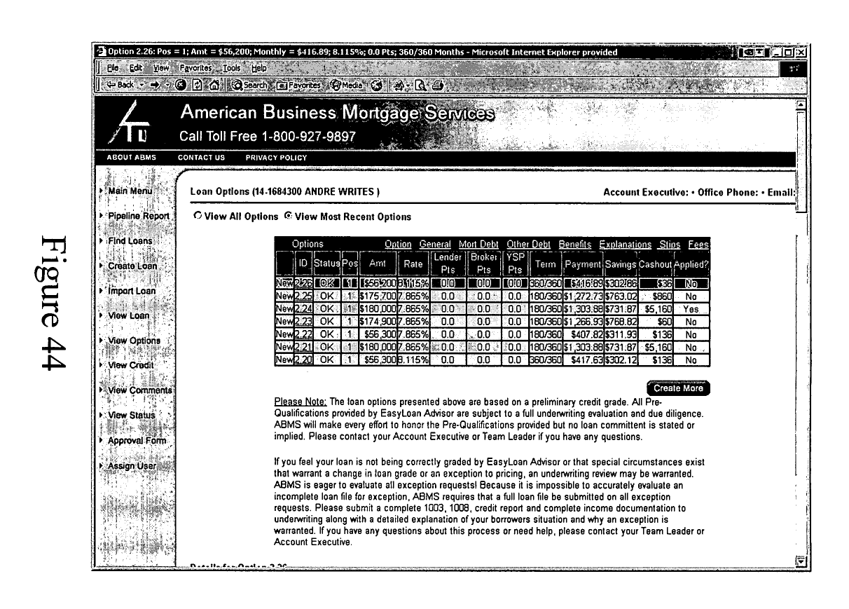

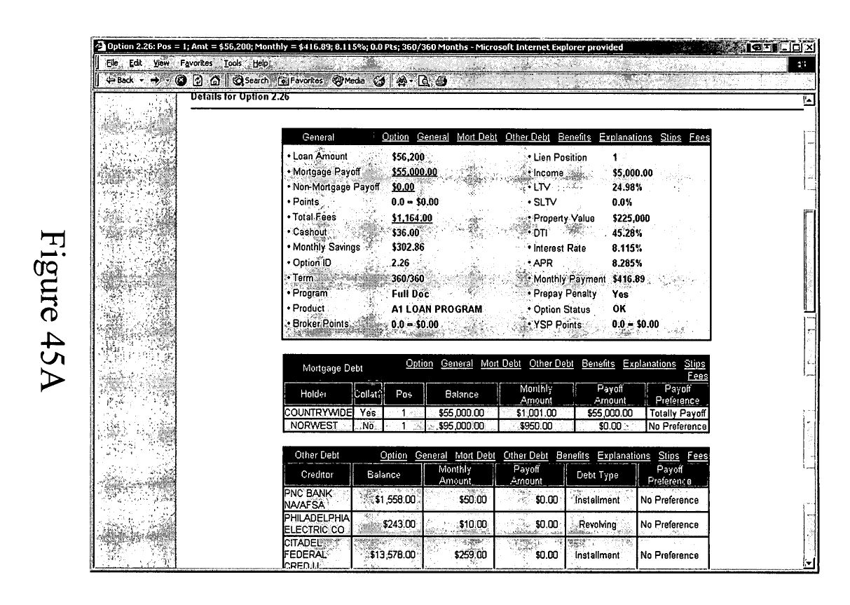

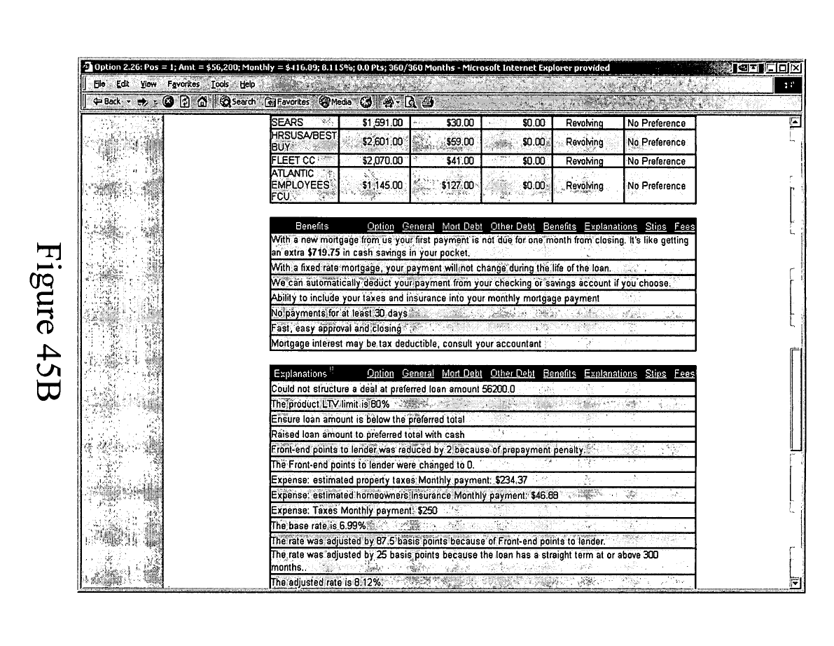

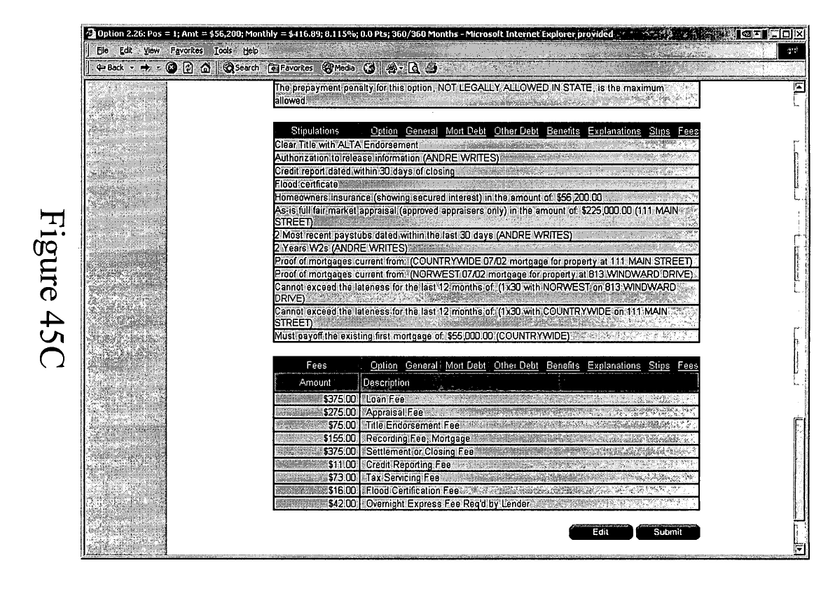

By clicking the “View Options” icon, as shown in FIG. 44, for example, a broker may view all or the most recent loan options made available for the borrower by the system. The list of loan options may be in a grid format and may include, for example, the loan ID, status, amount, rate, lender points, broker points, YSP, points, term, payment amount, savings, and cashout value. As illustrated by FIGS. 44 and 45A, information related to each option presented may be located below the grid table and may be accessed by scrolling down the page or clicking on the loan ID in the grid. The information presented for each option may include, for example, general information about the loan parameters, the current mortgage debt of the borrower, and other secured and unsecured debt of the borrower. The icon labeled “View Options” may include broker points. Broker points may be included, and if included may be greater than zero. Broker points may be presented in real time. Further, benefits and stipulations may be included in the display, or sent to customer 114, in real time. Since the present invention may incorporate a secure site, transmitted and entered information may be conveyed in a secure fashion.

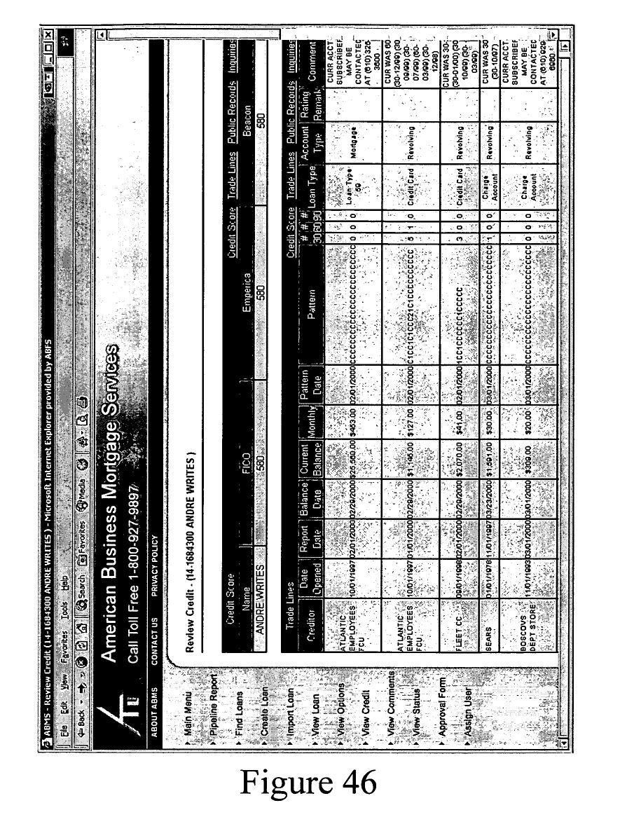

The consolidated credit history of the borrower may be viewed by clicking “View Credit” as shown in FIG. 44, for example. As illustrated in FIGS. 46 and 47, the system allows the broker to view the credit history of a borrower in a concise and sortable manner. For example, a grid may display information related to active and dormant trade lines of the borrower, which may include date open, current balance, monthly payment, pattern and pattern date, corresponding credit score, loan type, account type, rating remarks and keyed in comments if available, for example. This same grid may sort by any category described above, and further may be clickable links that may provide more detailed and/or searchable information in categories such as, credit score, trade lines, public records, and inquires, for example. Further, a grid may display just those values and information related to the borrower's credit score. A grid may also be displayed which may show information from public records, such as, for example, court records, tax liens, and other monetary obligations unrelated to mortgages or personal credit, such as property records and the like. Additionally, a grid may show inquiries from third parties, such as credit agencies, personal credit issuers, and lender and brokers, for example. This information, as with any grid formatted information of the system, may be sorted by the identifying column headers, which in this case may include the name of the inquiring party, the date of inquiry, account type, and bureau or agency, for example.

Further, as shown in FIG. 45B, a benefits list as described above, may be attached to each loan application providing critical selling points outlining the borrower's options in an effort to facilitate the selling of the loan by the broker. Benefits outlined by the system may include phrases such as “With a fixed rate mortgage, your payment will not change during the life of the loan” and “No payments for at least 30 days”, for example. An explanations, stipulations, and/or fees list may also be included, as shown in FIGS. 45B and 45C, respectively, and as described above.

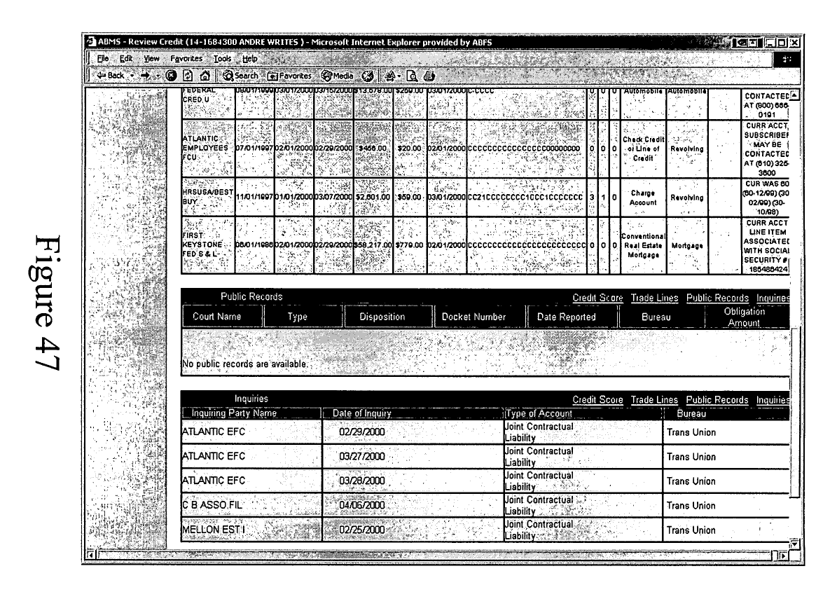

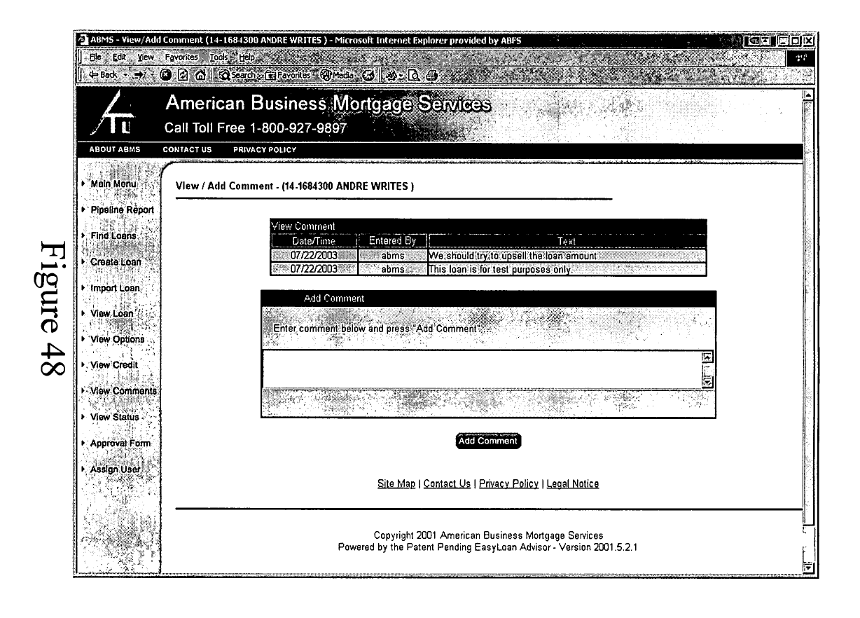

Additionally, as shown in FIG. 48, a “View Comments” screen may be accessed and may display at least one loan application for at least one borrower. This information entered for the borrower may include the date and time the information was entered, the user who entered the information, and comments entered, for example. Such comments may be entered in the field marked “Add Comments”, and may be added to the list of comments by clicking the “Add Comment” icon, for example. As would be known to those skilled in the art, comments entered in this fashion may also be deleted and/or expire over a defined time.

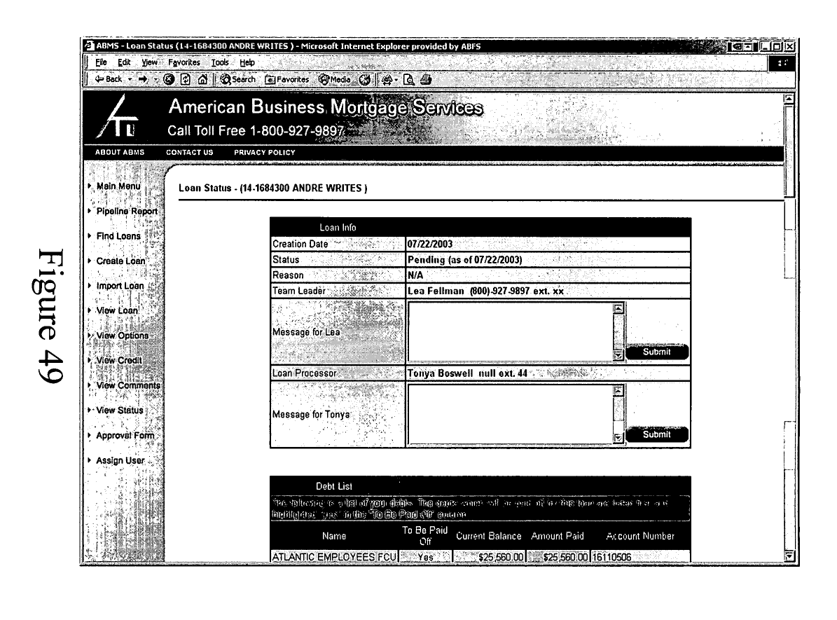

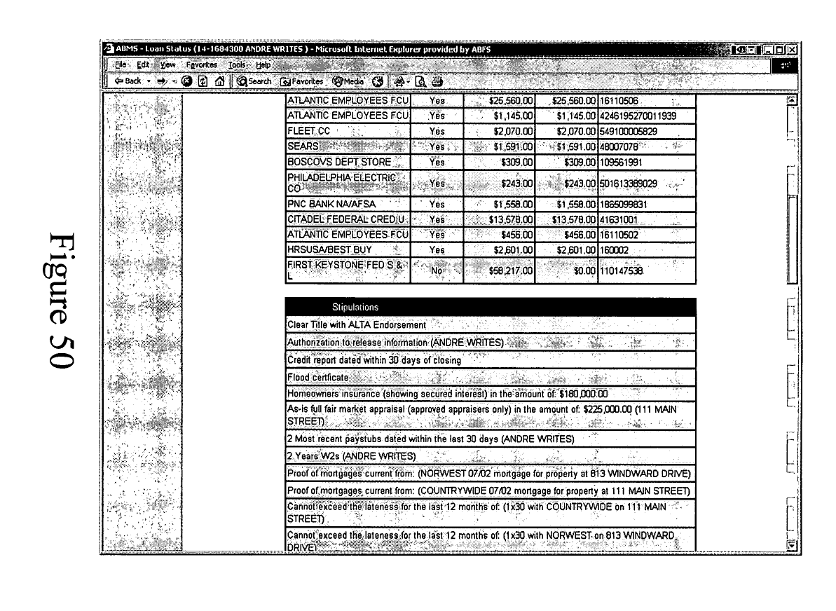

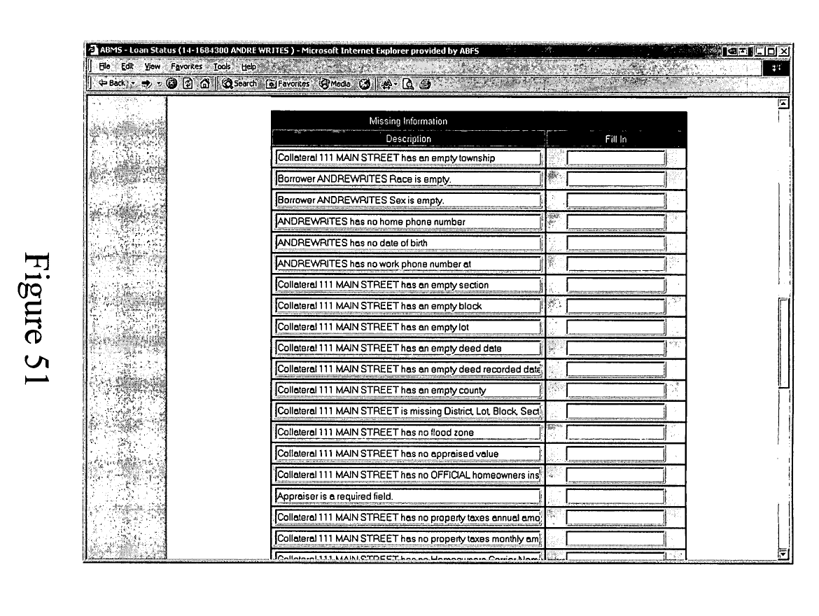

A broker may also view the status of at least one loan application, as illustrated in FIGS. 49-51. Access to this information may be achieved in any number of ways, including, but not limited to, utilizing the search functionality of the system to initially find the desired loan application, for example. This access may provide major categories of editable and fixed loan information, including, general loan information, a debt list, a stipulations list, and fields outlining information missing from the application, for example. A loan information portion may provide information such as creation date of the loan, and status, for example. This portion may also include third party contact information, which may include, for example, contact information for the administrator account executive and loan processor responsible for the loan application of interest. Further, fields are provided to allow messages to be sent to the listed third party contacts by entering a message and clicking on the “Submit” icon. As one skilled in the art would recognize, such communication may be expanded via the present invention to include instant messaging, video conferencing, and the like, for example. When communicating through the system with a third party, the communication may have attached thereto loan identification information, such as the loan ID number, for example. This automated identification may help eliminate confusion between the broker and a third party that could otherwise result in erroneous information given for a particular loan application.

A debt listing may also be provided, such as in a sortable grid format. This listing may include an identifying name of the debt, the status, current balance, amount paid, amount owed, and account number, for example. The list may also allow a broker to click on the name provided as the debtee, such as in order to receive more information, such as contact information for the debtee, for example.

Additionally, a listing which may include comments characterized as stipulations may be included when viewing the status of the loan. Such stipulations related to the loan application may include, but are not limited to, notes to the broker of special items needed for closing, instructions regarding title, the need for flood insurance, additional documentation needed from the customer 114 in order to qualify or close, as the case may be, for example. These stipulations may be entered by any party with access to the loan application, and may be edited, added, or deleted. Additionally, the stipulations may have access restrictions attributed to them such that members of one class of users may not view stipulations from a separate class of users. By way of non-limiting example only, a member of an administrative class may include, for example, an agent of the system administrator, which class may create stipulations that may only be viewed by a member of the same class. As one who is skilled in the art will recognize, rules based user access can create any number of user restriction combinations. Such user based restriction may be applied to any facet of the present system.

Missing information from the loan application may be highlighted when viewing the status of the loan application. Such information may be wholly absent from the application, or defective as incomplete or erroneous, for example. This missing information may be displayed in a column entitled “Description” and may detail the missing information, show that it is incomplete or erroneous, and may provide instructions for curing the missing information. By way of non-limiting example only, a description may include “Collateral 111 MAIN STREET has an empty township”, possibly indicating missing information related to the township in which the identified street is located, or “Appraiser is a required field”, possibly indicating the absence of some or all appraiser information. Corresponding fields may be provided with each missing information description, thereby enabling a valid user of the system to enter and/or correct the missing information. After entry of information into the desired field, the loan application may be automatically updated. Further, the system may also accept the uploading of forms, documents, and the like, which may be automatically updated into the loan application. This automatic updating may provide real-time loan application completion and help to speed the time to approval or closing of the subject loan.

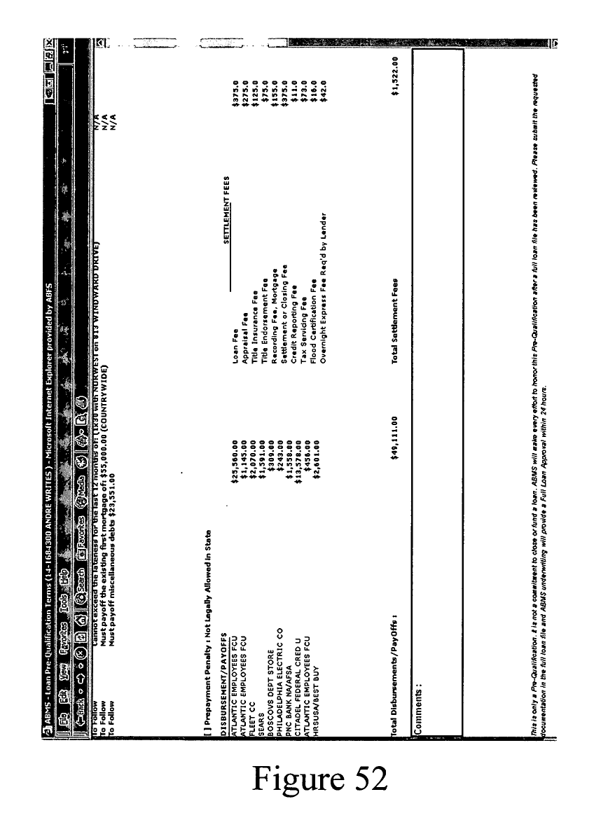

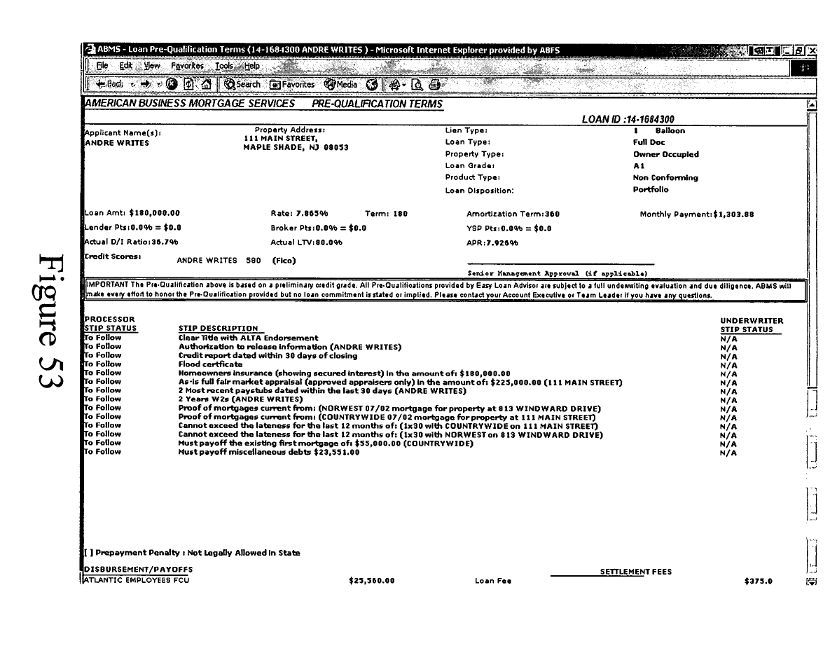

The approval of a loan application may be viewed and monitored within the system, such as by clicking on the “Approval Form” icon as shown in FIG. 44, for example. An approval form may summarize information applicable to the loan, including contact information, loan attributes, stipulations, comments, credit score, trade line information and settlement fees and distributions, for example, as illustrated in FIGS. 52 and 53. The approval of a loan by the administrator may be shown on the system instantaneously. Thus, a broker, for example, may be able to determine that a loan has been approved via the system as fast, or faster, than such knowledge would be conventionally available via telephone, mail, facsimile, or the like. This type of response will also decrease the time traditionally wasted between brokers and lenders trying to contact each other regarding the status of loan applications. Access to an approval form may also be limited by user and/or content, and such rules may be related to particular established by a valid users with access to the loan application. Such limited access may, as a non-limiting example only, allow one party to share only desired portions of loan approval information with another party and/or block access to some loan applications while allowing access to others.

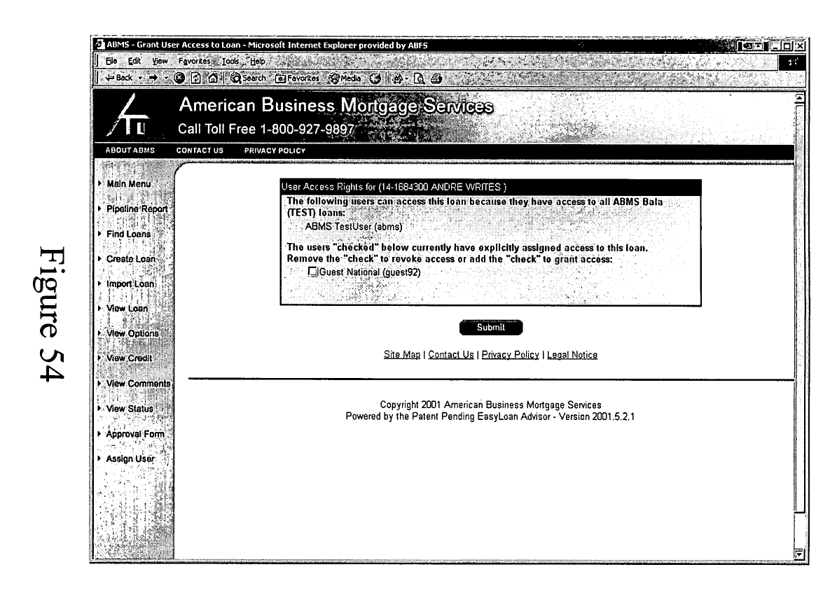

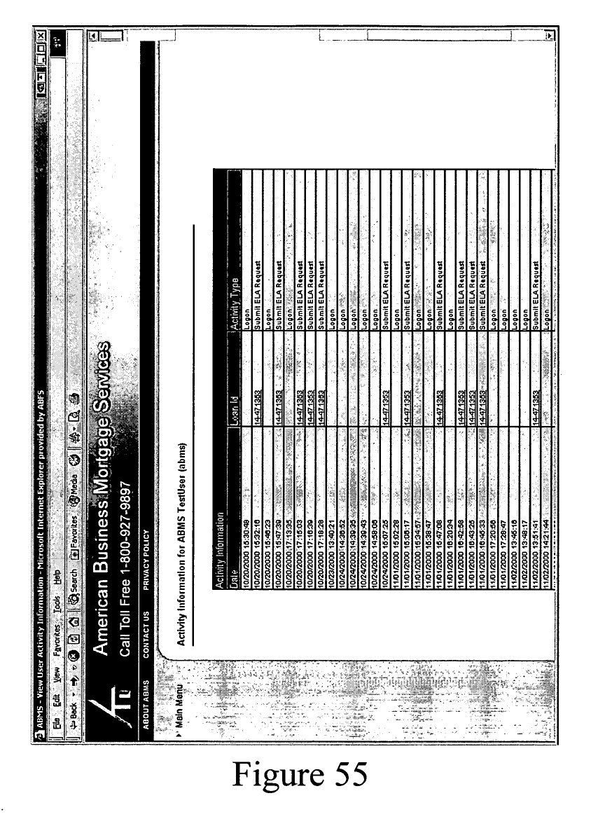

Further, a broker may edit any of at least one profile within the system by clicking, for example, on the icon “Assign User” as shown in FIG. 44, for example. As shown in FIG. 54, users of the system may have distinct access rights as compared to other users, and may, for example, be able to limit access to the system by subordinate users. By way of non-limiting example only, a broker who has rights in the system may limit the access of at least one subordinate user, such as an employee of the broker, for example. This limitation may include denying access to certain loans and/or certain information contained within the system. As shown in FIG. 55, all activity within the system by a user, and by any subordinate users, may be tracked and stored in an activity log. The information housed in this log may include, for example, the date and time of access, the loan accessed, if any, and the type of activities undertaken. Such information may be accessed by managers to review and manage the activities of employees, monitor workload, and understand system usage, for example.

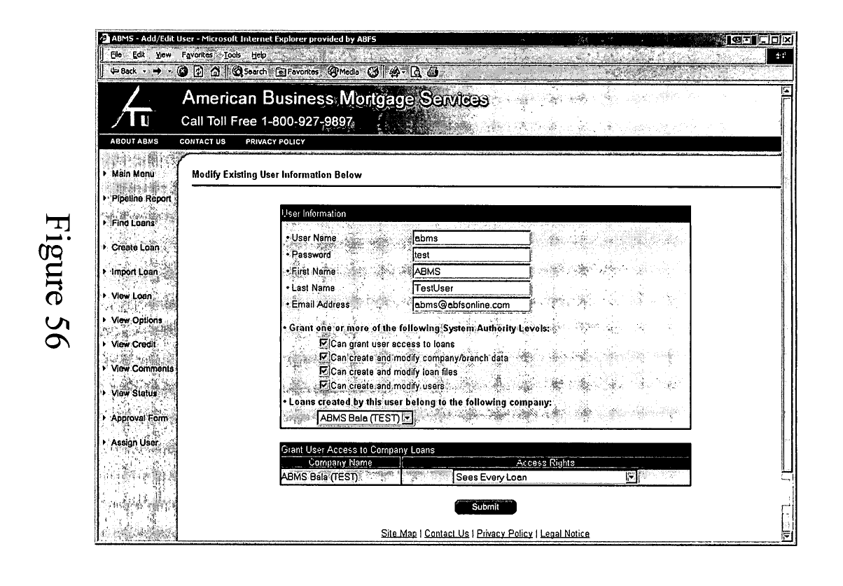

Further, as shown in FIG. 56, the broker may add additional users with varying access rights. This allows a user to be created by entering information such as user name, password, first and last name, and other contact information, for example. This may also allow the party creating the new user to select at least one authority level, which may include the ability to access to loans, create and modify company/branch data, create and modify loan files, and create and modify users, for example. The user may also be identified with a specific company, brokerage house, or the like. This may also provide for the assigning of access rights to the user.

Once information is entered for a new user, the user profile can be created by clicking the “Submit” icon for instant processing and subsequent access within the system. Such user profiles may be edited from time to time as necessary to accommodate the movement of employees and vary the access rights given to employees of varying seniority, for example. A user profile may also include such information as contact preferences, reporting preferences, and the like. By way of non-limiting example, a user may alter a profile so as to show a preference for being contacted via email rather than facsimile, for example, where other users may prefer receiving automated telephone calls from the system and/or other users.

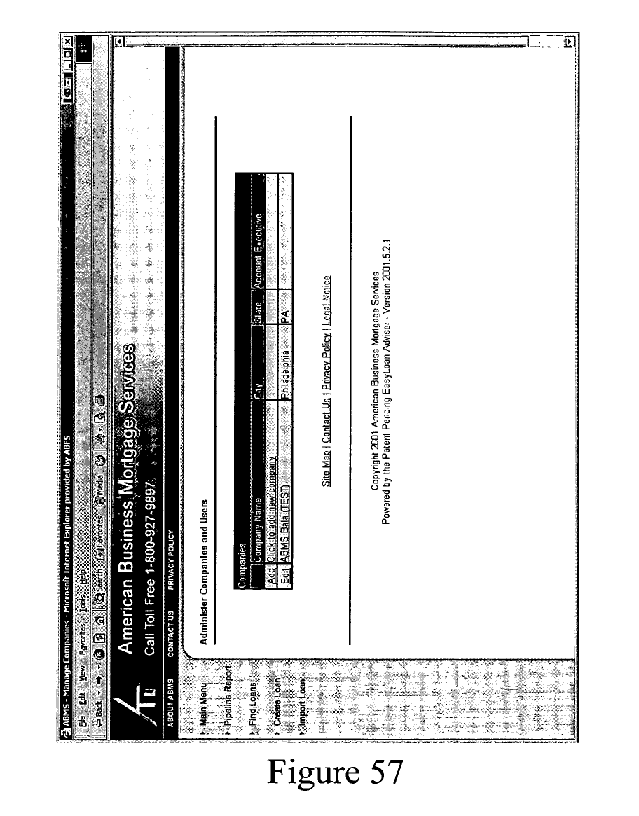

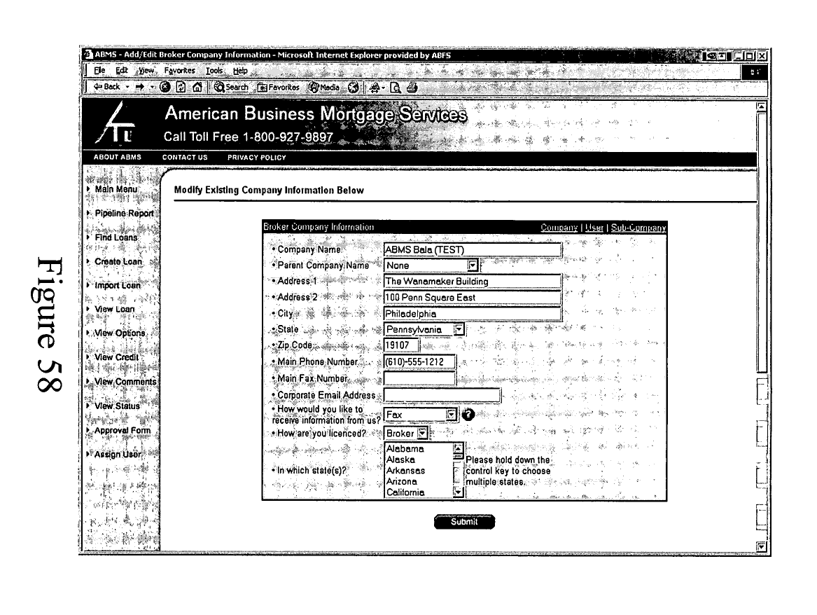

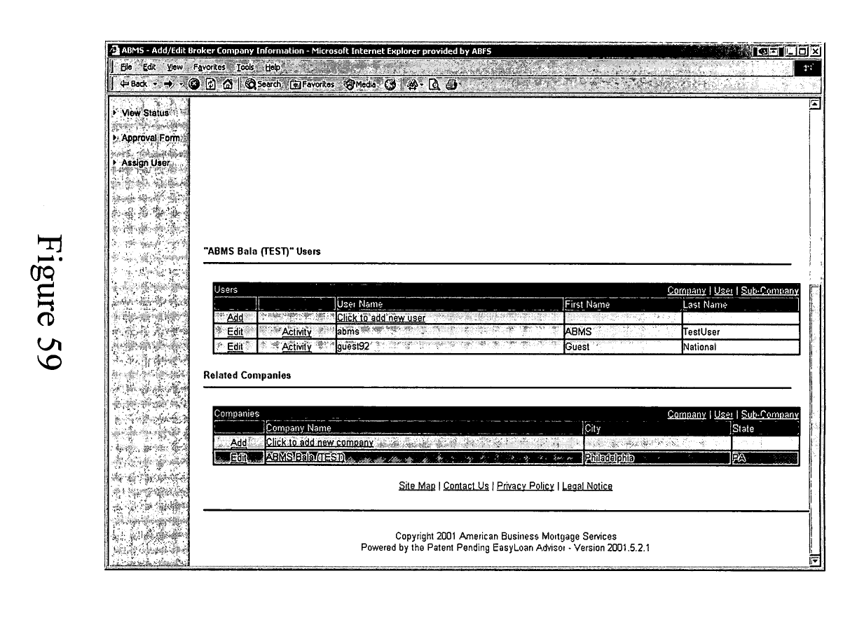

Additionally, as shown in FIG. 57, access to profiles on a company level may be gained by choosing at least one company listed for the user/broker, for example. These profiles can be edited and manipulated in the same manner as the individual user profiles as described above and as shown in FIG. 58. Further, as shown in FIG. 59, the system may provide for the addition, editing and deleting of users, companies, and profiles.

As would be evident to those possessing an ordinary skill in the pertinent arts, a myriad of possibilities exist as to what information is presented and what options exist for display. For example, contact lists of broker hierarchies may be presented. Further, a myriad of possibilities exist for the information that may be tracked in the system. For example, a list of brokers may be created and monitored to determine which broker sends the most business to what vendor or vendors.

Additionally, overseers may be able to obtain information accessible to those that are overseen. For example, a team leader or supervisor may be able to obtain particular loans that are being tended by a subordinate loan advisor. Such an overseer may be included on email distributions in order to properly monitor the loan process. Such an email, as discussed hereinabove, may occur manually or via an auto-email process.

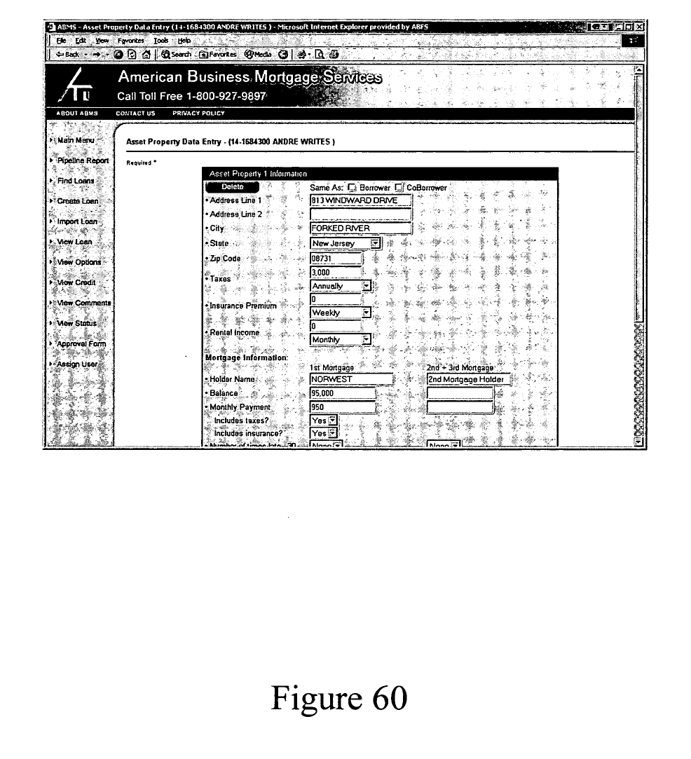

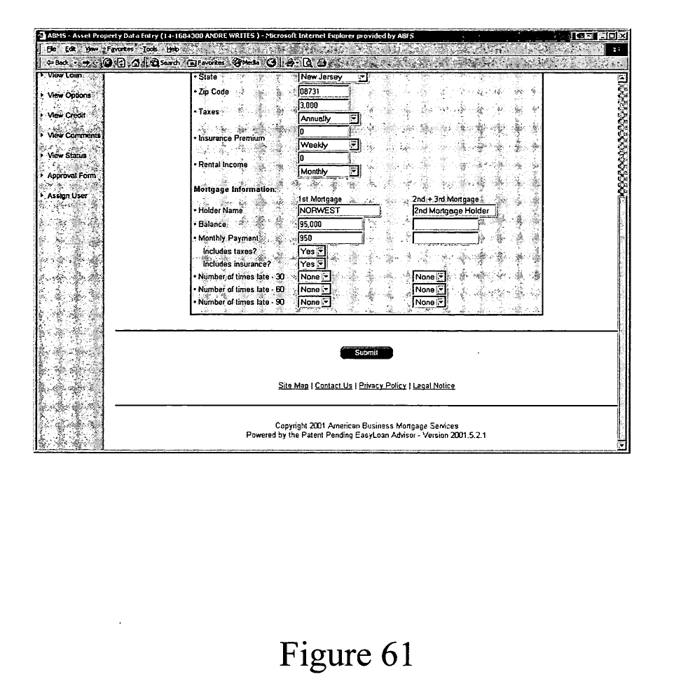

A broker may also add, delete, and edit asset property data as shown in FIGS. 60 and 61. Along with the ability to delete individual properties, the system may allow information specific to each property to be changed and/or added. The asset property information may also be populated automatically and may occur with the importing of loan information by the broker or importing previously entered information from within the system, for example. This information may include, but is not limited to, contact information, tax liability, insurance premiums, rental income, mortgage information, and associated payment timeliness, for example.

Upon completion of a loan product, such as when all of the details may be presumed to be completed, an approval may be delivered to all or a subset of the parties involved. This approval may occur via facsimile or email distribution, or both, for example. Additional transmission or notification means may be similarly utilized. This notification may be in the form of an approval form in real time, for example. This form may contain necessary provisions and may include an area for each individual involved or required to sign off on the loan.

Those of ordinary skill in the art will recognize that many modifications and variations of the present invention may be implemented. The foregoing description and the following claims are intended to cover all such modifications and variations.

TABLE 1
List of Common Elements Expressing
Customer's Desired Loan Parameters

| Item | Description |
|---|---|
| Term | Specified in months |
| Points | An upfront fee tacked on to the mortgage loan amount, |
| | each point equaling 1% of the mortgage loan amount |
| Mortgage | Specified as fixed, balloon, ARM and the like |
| loan type | |
| Lien position | Specified as 1st or 2nd position |
| Mortgage loan | The amount the borrower would like to borrow |
| amount | |
| Mortgage loan | Home purchase or, if a refinance mortgage loan, either |
| purpose | debt consolidation or cash out or both |
| Cash out | Amount of cash borrower would like to have from the |
| | mortgage loan |
| Documentation | Level of income documentation, if any, that the |
| type | borrower will provide in securing the mortgage loan |
| | (e.g. full documentation, no income qualification or no |
| | income verification). |
| Debts to pay off | Specification of debts borrower would like to pay off, |
| | debts borrower would not like to pay off, and debts to |
| | ignore (borrower claims debts are not theirs) |

TABLE 2
List of Exemplary Elements
Describing Collateral

| Item | Description |
|---|---|
| Owner | Name(s) |
| Location | Address, etc. |
| Value | Fair market value, purchase price, etc. |
| Taxes | Amount, frequency, etc. |
| Rental income | Amount, frequency, etc. |
| Occupancy | Owner occupied, not owner occupied, etc. |
| Property type | Single family, condominium, etc. |
| Liens | Lien holder, lien position, etc. |
| Property Insurance | Carrier, coverage amount, premium, etc. |

TABLE 3
List of Common Elements
Of Customer Information

| Item | Description |
|---|---|
| Entity type | Individual, proprietorship, corporation, partnership, |
| | etc. |
| Involvement type | Primary borrower, co-borrower, surety, etc. |
| Contact | Name, address, telephone number, etc. |
| General | Age, marital status, number of dependents, etc. |
| Citizenship | U.S. citizen, permanent resident alien, etc. |
| Employer | Duration of employment, salary, etc. |
| information | |
| Income and | Amount and frequency of each income and expense |
| expenses | |
| Residence | Intention to occupy property as primary residence, etc. |
| Self-declared | Outstanding judgments, bankruptcies and foreclosures |
| credit history | in past 7 years, litigation, delinquencies, other |
| | obligations, etc. |
| Account assets | List of accounts and balances |
| Other assets | Investments, life insurance, business interests, etc. |
| Home ownership | Owns own home, doesn't own a home and is not |
| | going to buy a home with this mortgage loan, etc. |

TABLE 4
Exemplary List of
Exclusionary Rules

| Item | Description |
|---|---|
| Property | IF Property Address is in one of a set of Excluded States, THEN bypass |
| Exclusionary | mortgage loan option generation. |
| Rules | IF Property Type is one of a set of Excluded Property Types, THEN |
| | bypass mortgage loan option generation. |
| | IF Property Type is ‘High-rise condo (>8 stories)’ AND Property |
| | Address is not Boulder, CO OR New York, NY, THEN flag for review by |
| | underwriter. |
| Borrower | IF Entity Type is a one of a set of Excluded Entity Types, THEN bypass |
| Exclusionary | mortgage loan option generation and route to appropriate department. |
| Rules | IF Borrower Citizenship is neither a ‘US citizen’ nor a ‘resident alien’, |
| | THEN bypass mortgage loan option generation. |
| | IF Borrower Home Ownership is ‘doesn't own a home and is not going to |
| | buy a home with this loan’ THEN bypass mortgage loan option |
| | generation. |
| | IF Borrower has a current bankruptcy, THEN proceed to mortgage loan |
| | option generation, but flag for review and do not return a generated |
| | mortgage loan option to borrower. |
| | IF the Borrower's credit cannot be graded because of FICO score or |
| | mortgage history, THEN bypass mortgage loan option generation and flag |
| | for review. |

TABLE 11
Repair Strategy for
Loan Amount

| | Repair Strategy | |
|---|---|---|
| Mortgage Loan | Mortgage Loan Amount Too | Mortgage Loan Amount |
| Purpose | Low | Too High |
| Cash Out | 1. Increase cash out | 1. Decrease debts to pay |
| | | off |
| Debt | 1. Increase debts to pay off | 1. Decrease cash out |
| Consolidation | | |
| Both | | 1. Equally decrease debts |
| | | to pay off and cash out. |

TABLE 12
Repair Strategy for
Loan-To-Value Ratio

| Mortgage Loan Purpose | Repair Strategy |
|---|---|
| Cash Out | Decrease debts to pay off |
| | Decrease points and increase rate |
| | Decrease cash out |
| Debt Consolidation | Decrease cash out |
| | Decrease debts to pay off |
| Both | Equally decrease debts to pay off and cash out |

TABLE 13
Repair Strategy for
Debt-To-Income Ratio

| Mortgage Loan | |
|---|---|
| Purpose | Repair Strategy |
| Cash Out | Extend term |
| | Increase mortgage loan amount to pay off more debt |
| | Reduce cash out to pay off more debt |
| | Reduce cash out |
| | Add points |
| Debt Consolidation | Extend term |
| | Increase mortgage loan amount to pay off more debt |
| | Reduce cash out to pay off more debt |
| | Reduce cash out |
| | Add points |
| Both | Extend term |
| | Increase mortgage loan amount to pay off more debt |
| | Reduce cash out to pay off more debt |
| | Reduce cash out |
| | Add points |

TABLE 14
Description of
Up-Sell Loan Options

| Up-Sell Mortgage Loan Option | Brief Description |
|---|---|
| Preferred Mortgage Loan Option Including: | The preferred mortgage loan option with increased loan |
| Pay Off All Debts and | amount sufficient to payoff all debts and provide $5000 |
| Provide $5,000 Additional Cash Out | additional cash out above the potential borrower's |
| | preferred cash out amount |
| Preferred Mortgage Loan Option Including: | If a 2nd lien, then the preferred mortgage loan with |
| Pay Off First Mortgage | increased loan amount sufficient to pay off the first |
| | mortgage |
| Preferred Mortgage Loan Option Including: | If a 2nd lien, then the preferred mortgage loan with |
| Pay Off First Mortgage and | increased loan amount sufficient to pay off the first |
| Provide $5,000 Additional Cash Out | mortgage and provide $5,000 additional cash out above |
| | the potential borrower's preferred cash out amount |
| Preferred Mortgage Loan Option Including: | The preferred mortgage loan option with loan amount |
| Maximize Cash Out | maximized to provide maximum cash out amount |
| Preferred Mortgage Loan Option Including: | The preferred mortgage loan option with loan amount |
| Minimize Total Monthly Debt Payment | maximized to provide the lowest monthly payment. |

TABLE 20
Exemplary Audience Table

| Field | Description |
|---|---|
| audience_id | Unique database generated identifier. |
| audience_description | Description of an audience, e.g., loan officer, |
| | broker, potential borrower, analyst, underwriter, |
| | etc. |

TABLE 21
Exemplary Benefits
Generation Rules

| | | |
|---|---|---|
| Order | Condition | Benefit Text |

Individualized Benefits

| | | |
|---|---|---|
| 1 | Borrower asked for cash out with a | “Based on what you told us you can receive up to |
| | particular purpose like new car in the | $X for the new car you want.” |
| | Advisor | |
| 2A | Borrower asked for cash out and they | “Based on what you told us you can receive the $: |
| | got it. | AMOUNT that you asked for.” |
| 2B | Borrower asked for debt consolidation | “One payment monthly versus: NUM- |
| | and they got it. | PAYMENTS” |
| 3A | Didn't ask for debt consolidation but | “Based on what you have told us, you could have |
| | we paid off only non-mortgage debt | an extra $: AMOUNT in your wallet each month |
| | and reduced their monthly payments. | by paying off non-mortgage debt.” |
| 3B | Didn't ask for debt consolidation but | “Based on what you have told us, you could have |
| | we paid off both mortgage and non- | an extra $: AMOUNT in your wallet each month |
| | mortgage debt and reduced their | by refinancing your mortgage and paying off |
| | monthly payments. | other existing debt.” |
| 4A | Borrower did not ask for cash out but | “Based on what you have told us, you have |
| | they got it any way. No mortgages | enough equity in your home to refinance and get |
| | paid off. | an extra $: AMOUNT to use any way you wish.” |
| 4B | Borrower did not ask for cash out but | “Based on what you have told us, you have |
| | they got it any way. A mortgage was | enough equity in your home to refinance and get |
| | paid off. | an extra $: AMOUNT to use any way you wish.” |
| 5A | Borrower did not ask for debt- | “Based on what you have told us, you can |
| | consolidation but we paid off only | consolidate $: AMOUNT of your non-mortgage |
| | non-mortgage debt and monthly | debt. This reduces non-mortgage debt from $: |
| | payments NOT reduced. | OLD-AMOUNT to $: NEW-AMOUNT.” |
| 5B | Borrower did not ask for debt- | “Based on what you have told us, you can |
| | consolidation but we paid off both | consolidate up to $: AMOUNT of outstanding |
| | mortgage and non-mortgage debt and | debt by refinancing your home.” |
| | monthly payments NOT reduced. | |
| 6 | Interest type is fixed rate. But actually | “With a fixed rate mortgage, your payment will |
| | now firing on all deals since we don't | not change during the life of the loan.” |
| | have any other product. | |
| 7A | Trade-lines payments remaining > term | Based on what you have told us, you can own |
| | (on mortgage) | your home free of mortgages x months sooner if |
| | | you refinance. |
| 7B | Trade-lines payments remaining > term | You will pay your debt off x months sooner |
| | (on non-mortgage) | |
| 8 | If debt paid off is foreclosure then | “You may be able to save your home by |
| | | refinancing prior to foreclosure” |

Default Benefits

| | | |
|---|---|---|
| 9 | Always | “Automatic deduction of payments |
| | | from your checking account.” |
| 10 | Always | “Interest on mortgage loans is usually |
| | | tax deductible - consult your tax |
| | | advisor.” |
| 11 | Always | “With a new mortgage from us your |
| | | first payment is not due for one month |
| | | from closing. It's like getting an extra |
| | | $: PAYMENT in cash savings in your |
| | | pocket.” |
| 12 | Always | “Ability to include your taxes and |
| | | insurance into your monthly mortgage |
| | | payment” |
| 13 | Credit Grade <= B2 | “Based on what you have told us, there |
| | | are ways we may be able to help you |
| | | repair your credit.” |
| 14 | If debt paid off is judgment, tax lien, charge off, | “You are repairing your credit by |
| | collection item | paying off your “collection item” of $: |
| | | AMOUNT” |

TABLE 22
Exemplary Documentation and Income
Stipulation Generation Rules

| Condition | Stipulation Text |
|---|---|
| Documentation Type = Full Documentation AND | 2 Most recent paystubs dated within the last 30 |
| Income Type = Salary/Hourly | days |
| | 2 Years W2's |
| Documentation Type = Full Documentation AND | 2 Years Personal and Business tax returns with |
| Income Type = Self-Employed | all schedules (Sched. C's, 1120, 1120S, K-1, |
| | etc.) |
| | 6 Months most recent consecutive bank |
| | statements |
| Documentation Type = Full Documentation AND | Copy of the Divorce Decree and Final Settlement |
| Income Type = Alimony | Agreement |
| | Copies of birth certificate(s) (if child support) |
| Documentation Type = Full Documentation AND | 2 Years tax returns |
| Income Type = Interest and Dividend Income | Account Statements |
| Documentation Type = Full Documentation AND | 2 Years tax returns or W2's |
| Income Type = Commissions | |
| Documentation Type = Full Documentation AND | Copy of notes receivable |
| Income Type = Notes Receivable | 2 Years tax returns |
| Documentation Type = Full Documentation AND | Copy of the Trust Agreement |
| Income Type = Trust Income | 2 Years tax returns |
| Documentation Type = Full Documentation AND | Signed Lease Agreements or most recent tax |
| Income Type = Rental Income | return including Schedule E |
| Documentation Type = Full Documentation AND | Original Award Letter |
| Income Type = Public Assistance | Copy of the 2 most recent check stubs |
| Documentation Type = Full Documentation AND | Copy of the Award Letter |
| Income Type = Social Security, Pension or Disability | 1099S, Current statement of benefits or most |
| | recent Bank Statement showing direct deposit |
| | Letter from physician is also required for proof |
| | the disability income will continue for at least 3 |
| | years |
| Documentation Type = Full Documentation AND | Award letter from the State |
| Income Type = Foster Care Income | Copy of the check stubs to verify income |
| Documentation Type = 24 Months Personal Bank Statements | Twenty four months most recent consecutive |
| | personal bank statements |
| | Business License for the past 2 years |
| Documentation Type = NIQ (No Income Qualification) | 2 Years tax returns with all schedules |
| | 6 months most recent consecutive bank |
| | statements |
| Documentation Type = NIV (No Income Verification) | Business License |
| | Bank statement with the business name, address |
| | and account number |

TABLE 23
Exemplary Customer Attribute
Stipulation Generation Rules

| Condition | Stipulation Text |
|---|---|
| Required on all mortgage loans | Clear title with ALTA Endorsement |
| Required on all mortgage loans | Credit report |
| Required on all mortgage loans | Full residential credit report |
| Required on all mortgage loans | Flood certificate |
| Required on all mortgage loans | Homeowners insurance (showing secured interest) in the |
| | amount of: $X |
| | [If our lien position is one (1), the amount of coverage X |
| | shall be equal that of our loan amount. If our lien |
| | position is two (2), the amount of coverage X shall be |
| | equal to the current balance of the first lien plus our |
| | loan amount.] |
| Required on all loans where the collateral property is | Flood insurance (showing secured interest) in the |
| located in a flood zone. | amount of: $X |
| | [If our lien position is one (1), the amount of coverage X |
| | shall be equal to that of our loan amount. If our lien |
| | position is two (2), the amount of coverage X shall be |
| | equal to the current balance of the first lien plus our |
| | loan amount.] |
| Required on all loans | ‘As Is’ full fair market appraisal (approved appraisers |
| | only) in the amount of: $X |
| Required on all loans when the borrower(s) has a loan | Proof of mortgages current from: MM/YY |
| secured by real estate (mortgage, secured credit line . . . ) | [MM/YY is the last reporting date of each mortgage on |
| regardless if it is on the collateral or asset property. | the credit report. If the mortgage(s) are not on the credit |
| | report, the value to be used is the deal structuring date |
| | minus one (1) year. |
| | For example, if the deal structuring date is Jan. 11, 2000, |
| | MM/YY is January 1999.] |
| Required when our borrower(s) does not own, but rents | Proof of rental payment current from: MM/YY |
| the property in which he currently resides. | [X the deal structuring date minus one (1) year. |
| | For example, if the deal structuring date is Jan. 11, 2000 |
| | MM/YY is January 1999.] |
| Required on all loans when we are in second (2nd) lien | Proof of monthly mortgage payment in the amount of: |
| position. | $X |
| | [X is the monthly payment amount of the lien in the first |
| | position in which we are taking a second (2nd) behind.] |
| Required when the borrower(s) is obligated to repay a | Cannot exceed the lateness for the last 12 months of: X |
| loan that is secured by real estate (mortgage, line of | The value X is the maximum number of mortgage or |
| credit . . . ) or pays a monthly rental expense | rental late payments allowed by any particular loan |
| | grade within the last 12 months. |
| | A++ = 0 late payments of 30 days |
| | A1 = 1 late payment of 30 days |
| | A2 = 2 late payments of 30 days |
| | A90 = 2 late payments of 30 days |
| | B1 = 3 late payments of 30 days |
| | B2 = 4 late payments of 30 days |
| | C1 = 4 late payments of 30 days, 1 late |
| | payment of 60 days |
| | C2 = 4 late payments of 30 days, 2 late |
| | payments of 60 days |
| | D1 = 1 late payment of 120 days |
| Required when we are doing a loan in the first lien | Must payoff the existing first mortgage of: $X |
| position and we are paying off the existing first | [X is the payoff amount for the existing first mortgage.] |
| mortgage. | |
| Required when we are doing a loan in the second lien | Must payoff the existing second mortgage of: $X |
| position and we are paying off the existing second | [X is the payoff amount for the existing second |
| mortgage. | mortgage.] |
| Required on all loans where any non-mortgage debts are | Must payoff miscellaneous debts |
| being paid off. | |
| Required on all loans where we are doing a mortgage in | Copy of the first mortgage note |
| the second lien position. | |
| Required on all loans where we are doing a mortgage in | Proof the taxes are escrowed in the first mortgage |
| the second lien position. | [If the taxes are included in the first mortgage payment, |
| | the value will be “Escrowed”. If the taxes are not |
| | included in the first mortgage payment the value will be |
| | “Not Escrowed”.] |
| Required on all loans where we are doing a mortgage in | Proof the insurance is escrowed in the first mortgage |
| the second lien position. | [If the homeowners insurance is included in the first |
| | mortgage payment, then the value will be “Escrowed”. |
| | If the homeowners insurance is not included in the first |
| | mortgage payment, then the value will be “Not |
| | Escrowed”.] |
| Required on all purchase money transactions. | Copy of the Sales Agreement executed by all parties |
| Verification of down payment (escrow letter) | Verification of down payment (escrow letter) |
| Required on all purchase money transactions. | Three months bank statements OR VOD showing |
| | sufficient funds to close |
| Required on all mortgage loans we make to pay off a | Copy of the Land Sales Contract |
| land contract. | |

TABLE 24
Exemplary Miscellaneous
Stipulation Generation Rules

| Condition | Stipulation Text |
|---|---|
| If Marital Status = Divorced | Copy of Divorce Decree Required |
| If Marital Status = Separated | Copy of Divorce Separation agreement Required |
| If Marital Status = Widow | Copy of Divorce Death certificate Required |
| If Bankruptcies AND Foreclosures In Past 7 Years = Prior | Copy of Divorce Discharge notice Required |
| Bankruptcy | |
| If Outstanding Judgments = In Bankruptcy | Copy of Divorce Payoff from trustee and schedules |
| | of debts Required |
| If Property Type = Condo | Copy of Divorce Condo association bylaws Required |
| If Occupancy = Non-owner occupied | Copy of Divorce Current leases Required |
| If Home Ownership = Owned property less then 1 year | Copy of Divorce Copy of deed Required |

What is claimed is:

1. A method of automatically generating, based on the preferences of a potential borrower as entered by a third party, multiple alternative loan proposals requested by the third party, comprising:
prompting the third party for at least one loan parameter;
requesting from the third party information relating to the potential borrower;
accessing in substantially real time information relating to the credit history of the potential borrower;
applying at least one loan origination rule to the at least one loan parameter and the information relating to the potential borrower;
applying at least one strategy to at least one result of said applying at least one loan origination rule;
generating at least two loan proposals in accordance with the at least one result of said applying at least one loan origination rule and said applying at least one strategy, wherein at least one loan proposal is automatically approved, and wherein each loan proposal includes a plurality of loan proposal factors; and
presenting the third party with the at least two loan proposals for presentation to the potential borrower.

2. The method of claim 1, wherein the at least one loan parameter comprises the gross amount of the loan.

3. The method of claim 1, wherein the at least one loan parameter comprises the proceeds of the loan.

4. The method of claim 1, wherein the at least one loan parameter comprises the monthly payment due under the terms of the loan proposal.

5. The method of claim 1, wherein the at least one loan parameter comprises the total monthly debt service that the potential borrower would be required to pay for the loan proposal and the existing debts of the potential borrower not be discharged with the proceeds of the proposed loan.

6. The method of claim 1, wherein the at least one loan parameter comprises the loan term.

7. The method of claim 1, wherein the at least one loan parameter comprises the number of points payable by the potential borrower.

8. The method of claim 1, wherein the at least one loan parameter comprises the loan interest rate.

9. The method of claim 1, wherein the information provided by the third party comprises information relating to the collateral offered by the potential borrower.

10. The method of claim 9, wherein the information relating to the collateral comprises the lien position of the lender in the collateral.

11. The method of claim 9, wherein the information relating to the collateral comprises the type of collateral offered by the potential borrower.

12. The method of claim 9, wherein the information relating to the collateral comprises information relating to the identity of collateral offered by the potential borrower.

13. The method of claim 1, wherein the at least one loan parameter comprises a fixed loan interest rate.

14. The method of claim 1, wherein the at least one loan parameter comprises a balloon loan.

15. The method of claim 1, wherein the at least one loan parameter comprises a prepayment penalty.

16. The method of claim 1, wherein the at least one loan parameter comprises a variable interest rate.

17. The method of claim 1, wherein the information relating to the potential borrower comprises the amount of the income of the potential borrower.

18. The method of claim 1, wherein the information relating to the potential borrower comprises the amount of debts of the potential borrower.

19. The method of claim 1, wherein the information relating to the potential borrower comprises the name of the potential borrower.

20. The method of claim 1, wherein the information relating to the potential borrower comprises the taxpayer identification number of the potential borrower.

21. The method of claim 1, wherein the information relating to the potential borrower comprises that the potential borrower is an individual.

22. The method of claim 1, wherein the information relating to the potential borrower comprises information relating to the spouse of the potential borrower.

23. The method of claim 1, wherein the information relating to the potential borrower comprises the objective of the potential borrower in applying for the loan.

24. The method of claim 1, wherein the information relating to the potential borrower comprises information relating to the credit history of the potential borrower.

25. The method of claim 1, further comprising the step of:
storing the at least one loan parameter received from the third party in response to the said prompting and storing the information relating to the potential borrower received from the third party in response to said prompting and requesting.

26. The method of claim 25, wherein the at least one loan parameter and the information relating to the potential borrower are individually stored in a database.

27. The method of claim 1, wherein the at least one loan origination rule is stored in a knowledge base.

28. The method of claim 1, wherein the at least one loan origination rule is applied to the data received from the third party in response to said prompting and requesting using an inference engine.

29. The method of claim 1, wherein the at least one loan origination rule is applied to the data received from the third party in response to said prompting and requesting using an expert system.

30. The method of claim 1, wherein said accessing comprises receiving a credit report electronically from a credit report provider.

31. The method of claim 1, wherein said accessing comprises accessing a stored credit report received electronically from a credit report provider.

32. The method of claim 1, wherein said accessing comprises accessing information stored in a database.

33. The method of claim 1, wherein the at least one loan origination rule comprises at least one rule relating to the type of borrower.

34. The method of claim 33, wherein the at least one rule relating to the type of borrower comprises a rule for rejecting any borrower that is not a natural person.

35. The method of claim 1, wherein the at least one loan origination rule comprises at least one rule relating to the state of residence of the potential borrower.

36. The method of claim 1, wherein the at least one loan origination rule comprises at least one rule relating to the state in which offered collateral is located.

37. The method of claim 1, wherein the at least one loan origination rule comprises at least one rule relating to the ratio of the proposed amount of debt secured by offered collateral to the value of the collateral.

38. The method of claim 37, wherein the at least one rule relating to the ratio of the proposed amount of debt secured by the offered collateral to the value of the collateral comprises a rule for rejecting any third party if the ratio of the proposed amount of debt secured by the offered collateral to the value of the collateral exceeds a predetermined value.

39. The method of claim 37, wherein the at least one rule relating to the ratio of the proposed amount of debt secured by the offered collateral to the value of the collateral comprises a rule for increasing the interest rate of the loan if the ratio of the proposed amount of debt secured by the offered collateral to the value of the collateral exceeds a predetermined value.

40. The method of claim 1, wherein the at least one loan origination rule comprises at least one rule relating to the ratio of the income of the potential borrower to a predetermined percentage of the total debt that the potential borrower would have if the loan were approved and consummated.

41. The method of claim 1, wherein the loan origination rules comprise at least one rule relating to the ratio of the income of the potential borrower to the total monthly payment relating to all of the debts of the potential borrower that the potential borrower would have if the loan were approved and consummated.

42. The method of claim 1, wherein the at least one strategy comprises generating an alternative proposed loan with a greater loan amount.

43. The method of claim 1, wherein the at least one strategy comprises repairing a rejected loan by altering loan parameters.

44. The method of claim 43, wherein the loan amount is decreased.

45. The method of claim 43, wherein the number of points is increased.

46. The method of claim 43, wherein loan proceeds are used to discharge additional debts.

47. The method of claim 43, wherein loan proceeds are used to discharge senior indebtedness.

48. The method of claim 43, wherein the interest rate is increased.

49. The method of claim 43, wherein the loan term is lengthened.

50. A computer-readable medium tangibly embodying instructions which, when executed by a computer, implement a process comprising the steps of:
prompting a third party for at least one loan parameter;
requesting from the third party information relating to a potential borrower;
accessing in real time information relating to the credit history of the potential borrower;
applying at least one loan origination rule to the at least one loan parameter and the information relating to the potential borrower;
applying at least one strategy to at least one result of said applying;
generating at least two loan proposals in accordance with the at least one result of said applying at least one loan origination rule and said applying at least one strategy, wherein at least one loan option is automatically approved for a choice of at least one of the at least two loan proposals, and wherein each loan proposal includes a plurality of loan proposal factors;
presenting the third party with the at least two loan proposals, wherein the third party may present the at least two loan proposals to the potential borrower;
wherein the information provided by the third party comprises information relating to the collateral offered by the potential borrower.
